(19) United States
(12) Patent Application Publication
(10) Pub. No.: US 2022/0095710 A1
(43) Pub. Date: Mar. 31, 2022

(54) INFLATABLE MOTORCYCLE OUTFIT

(71) Applicant: Airbag Inside Sweden AB, Göteborg (SE)

(72) Inventor: Moses Shahrivar, Fiskebäckskil (SE)

(21) Appl. No.: 17/425,362

(22) PCT Filed: Feb. 7, 2020
(86) PCT No.: PCT/SE2020/050126

§ 371 Date: Jul. 23, 2021

Related U.S. Application Data
(60) Provisional application No. 62/803,641, filed on Feb. 11, 2019.

(51) Int. Cl. A41D 13/018; A41D 31/18

(52) U.S. Cl. CPC A41D 13/018; A41D 2600/102; A41D 31/18

(57) ABSTRACT

This disclosure relates to a system and method for an inflatable motorcycle outfit. The system comprises an inflatable trouser, an inflatable jacket, a pair of inflatable boots, one or more inflatable canopies. The system is flat when worn by the rider, resembling ordinary clothing and inflates in the event of a motorcycle accident. The system reduces the speed of a rider when the inflatable canopies are deployed by inflation, thus reducing the overall impact force the rider is facing in an accident situation. The system offers impact reducing protection for the rider by having a barrier of inflatable air tunnel structures inside or outside the outfit that absorbs impact energy in an accident situation when inflated. The air tunnel shells and the outfit are made from material with abrasion resistant, heat resistant, and/or stretchable properties.

### RELATED APPLICATION(S)

This application claims the benefit of U.S. Provisional Application No. 62/803,641, filed Feb. 11, 2019, the entirety of which is herein incorporated by reference.

### TECHNICAL FIELD

The present disclosure relates to an inflatable motorcycle outfit that rapidly inflates during a motorcycle accident to reduce impact injuries.

### BACKGROUND

Traditional motorcycle clothing have soft- or hard-shell protectors to absorb impact forces in an accident situation. Only selected parts of traditional motorcycle clothing have protectors, leaving most of the body unprotected from impact forces in the event of a motorcycle accident. Some riders prefer no protective clothing at all. Such riders prefer the comfort and style of regular clothes such as jeans because of the ornamental design of protective clothing are function-oriented, awkward, disturb the ride, often uncomfortable, hot, and lead to irritation.

Insurance companies do not cover riders without protective motorcycle clothes in a motorcycle accident and provide limited or no economic help to injured riders when using regular jeans in an accident situation. Riders are aware of the issues, but they prioritize design and comfort of regular clothes over safety.

There are no jeans or protective trousers that covers most of the lower body with impact reducing protection for motorcycle riding.

I tried to solve the problem of riding in jeans by creating leather-lined motorcycle jeans with knee protectors in 2005. The leather-lined jeans were approved as protective motorcycle apparel by insurance companies in Sweden which enabled riders to be covered by their motorcycle insurance in the event of an accident. The leather-lined jeans were considered an innovation at the time and launched in collaboration with a big motorcycle brand in 2006. The leather-lined jeans solved the abrasion issue, while allowing riders to ride wearing jeans, but did not solve the most important issue that causes the most severe injuries, which are the impact forces riders are facing in an accident situation. The leather-lined jeans only offered impact reducing protection for the knees, leaving the rest of the lower body unprotected from impact forces.

Other people have tried to solve the issue of riding in jeans by lining jeans with abrasion resistant fabrics such as aramid, as in U.S. Pat. No. 5,918,319. Other solutions have been to make the denim fabric abrasion resistant. Abrasion resistant jeans are today common on the motorcycle market worldwide but does not solve the impact issue for the lower body. Abrasion resistant motorcycle jeans offer hard- or soft-shell protectors for selected parts, leaving most of the body unprotected from impact forces.

According to, U.S. Department of Transportation—National Highway Traffic Safety Administration Study: “Lower Extremity Injuries in Motorcycle Crashes”, the lower body suffers more injuries than the upper body in an extreme motorcycle accident. The injuries on the lower body parts are less life threatening but tend to be more permanent because the rider survives. This makes the long-term costs for the society much higher for injuries occurring on the lower body parts than on the upper body parts. According to that study, the distribution of the lower extreme injuries in motorcycle crashes, according to the study are, leg 27%, pelvis 18%, knee 16%, thigh 11%, foot 10%, ankle 10%, hip 4% and other 4%.

Abrasion resistant motorcycle jeans with hard- or soft-shell protectors offers impact reducing protection for the knees which is the 3^{rd} most extreme injury, and the hips which is the 7^{th} most extreme injury. Abrasion resistant motorcycle jeans only offer impact reducing protection for 20% of the list composed by U.S Department of Transport, the rest are left unprotected. Soft- or hard-shell protectors are only available for the front and the outer-side of the lower legs, further, the knees and the hips. The impact reducing protection available on the market offer low or no impact reducing protection for the most common injury occurring to the lower body in a serious motorcycle accident, which are injuries to the legs. Abrasion resistant motorcycle jeans or trousers are not successful in protecting the lower body against impact forces, the focus of motorcycle trousers has been to protect the body from abrasion forces which causes less severe injuries compared to injuries from impact forces. Airbag trousers or jeans are not available on the motorcycle market.

Inflatable impact reducing protection are available on the motorcycle market for the upper body as airbag vests for the front and back of the rider's torso without any inflatable device for protecting the limbs. One such example is U.S. Pat. No. 7,007,307 to Kenji Takeuchi which describes an airbag vest that protects the torso but not the limbs, and further describes the use of an air tube with two materials placed on each other to form a generic shell for the air tube to be placed inside. Mr. Takeuchi's airbag vests have been available on the motorcycle market since 1998 and are leading within the field of airbag vests for motorcyclists. Mr. Takeuchi is considered a pioneer in the field. Mr. Takeuchi's construction of the air tube shells does not enable the shells to fit inside the arms of a jacket or the legs of a trouser because of the limited space in those areas.

Mr. Takeuchi and others have attempted to solve the issue of protecting the limbs with inflatable means. One such example is U.S. Pat. No. 4,977,623, which describes the construction of an inflatable vest but does not disclose how the limbs are protected with inflatable means. This indicates that that the solution for protecting the limbs with inflatable means was not truly solved.

Known airbag vests available on the motorcycle market have a separation-distance that must be reached for the airbag to inflate, meaning the rider must be separated from the vehicle and reach a distance before inflation can happen. This delays the crucial inflation time in an accident situation were rapid inflation is vital. Further, the airbag vests do not have an instant deflation solution, once the airbag is inflated the rider needs to wait 5-7 minutes before the airbag self-deflates. The inflated airbag reduces movability for the rider and makes medical treatment harder after an accident situation. Further, the airbag in the vest is not detachable from the vest which makes washing difficult, the airbag vest cannot be washed in a washing machine. Further, the airbag vests do not have a solution for connecting multiple airbag garments to one motorcycle. Further, airbag vests are marketed as airbag jackets, the airbag jackets use the construction of the airbag vest inside of a jacket with traditional soft- or hard-shell protectors for the shoulders and the elbows. The airbag jackets are not using inflatable means to protect the limbs of the upper body.

Further, traditional motorcycle boots protect the feet of a rider with the outer shell material and with soft- or hard-shell protectors in specific areas of the boots. Motorcycle boots use traditional methods for protecting the feet in comparison to inflatable means that absorbs energy differently. Inflatable shoes or boots for motorcycle riders does not exist on the motorcycle market. Inflatable shoes are available for walking on water and as entertaining leisure products.

High-speed riders are facing the most dangerous impact and abrasion forces in the event of a motorcycle accident due to the high-speeds involved. There are no products available on the motorcycle market that can reduce the speed of a rider and thus reduce the overall forces from an accident. Attempts have been made to reduce the speed of a rider, as in U.S. Pat. No. 8,240,610. The '610 patent describes a non-inflatable parachute, a non-inflatable canopy structure, located on the back of the rider, on the spinal column, ejecting a parachute backwards that deploys with the help of the wind in the event of a motorcycle accident. The parachute relies on the wind to catch and deploy the canopy which can malfunction due to the motion and orientation of the rider in an accident situation. Further, the placement of the parachute on the spinal column makes the wind stopping force to be absorbed horizontally by the upper body which can cause severe injuries the moment the canopy catches the wind. Riders risk injuries if the parachute would be deployed in high speeds. Further, the multiple suspenders connected on the back of the rider risks getting caught around the neck of the rider in an accident situation were the rider rolls around on the ground.

When riding motorcycles on a racetrack the rider has no possibility to reduce the speed if an accident occurs. The rider must slide on the ground until the abrasion forces or an abrupt impact force stops the rider, thus causing injuries.

Another problem non-professional riders face while riding on a racetrack is that nobody is timing the lap. The rider is unable to time himself or herself and has no clue if the riding has improved or not.

### SUMMARY

The present disclosure reduces injuries in a motorcycle accident situation by offering riders an inflatable motorcycle outfit, such as that shown in FIGS. 1, 2, 3, 6, 7, 11, 12, 16, 17, 18, 21, to wear when riding.

The outfit of the present disclosure provides, among other things, inflatable impact and abrasion reducing protection for the feet (FIG. 20), lower body (FIG. 5), upper body including the arms (FIG. 10) and the sides of the head (FIG. 14) in an accident situation. The outfit further offers speed reducing abilities with inflatable canopies (FIG. 13) that can reduce the impact speed and the overall forces a rider is facing in an accident situation.

The outfit as FIG. 1 illustrates comprises an inflatable trouser 1, an inflatable jacket 2, an inflatable vest 3 with one or more inflatable canopies and an inflatable boot 4. The outfit is designed to resemble ordinary clothing, as shown in FIGS. 2-11, with airtunnel (i.e., air tunnel, fluid tunnel, or simply tunnel) shells 13 (FIG. 21) inside the garments of the outfit. The outfit rapidly inflates airproof airtunnels 12 located inside the airtunnel shells 13 with gas or fluid. The airproof airtunnels for the outfit will be referred to as airtunnel or airtunnels. The airtunnel shells 13 are illustrated inflated in FIG. 21 and can be attached inside, outside or arranged together with the trouser of FIGS. 2, 3, 6, 7, jacket of FIGS. 11, 12, vest of FIG. 16 and boots of FIG. 17 in the outfit. While the outfit herein includes a trouser, jacket, vest, and boots, it should be understood that this disclosure extends to various combinations of trousers, jackets, vests, and boots, and is not limited to a combination of all four items. For instance, this disclosure may, in some examples, covers trousers in isolation from the various other items in the example outfit of FIG. 1. In another instance, the disclosure may cover outfits having trousers and a vest as arranged herein, without boots or jacket. While the outfit herein includes an electrical inflation trigger house 23 and a mechanical inflation trigger house 17 it should be understood that all the garments can use either an electrical inflation trigger house 23 or a mechanical inflation trigger house 17.

The outfit further comprises a new material (FIG. 29) for making the airtunnel shells 13. The material offers abrasion and heat resistant protection for the airtunnels 12 in the outfit and the rider. The new material comprises abrasion and heat resistant fibres (FIG. 31) with high tensile strength.

The outfit further comprises a new material (FIG. 26) for making the outer shell of the trouser (FIGS. 2, 3), jacket (FIG. 11) and vest (FIG. 16). The material enables inward inflation for the outfit and offers abrasion resistant protection for the airtunnel shells 13, the airtunnels 12 and the rider. The material comprises stretchable fibres 57, natural fibres 56 and abrasion resistant fibres 58 (FIGS. 27-28). The material resembles ordinary denim fabric when obtained by weaving (FIG. 27), enabling riders to ride in stretchable, impact and abrasion resistant motorcycle jeans (FIG. 2).

The outfit further comprises mechanical inflation trigger housings (FIGS. 22-26) attached to airtunnels 12 in the outfit. The mechanical inflation trigger housings 17 have high pressured gas or fluid tanks 14 shaped as the male part of a quick release air coupling connection 15 to the trigger housings 17 shaped as the female part of a quick release air coupling connection 16. Once the outfit is inflated the tanks can quickly be removed from the trigger housings using the quick release for instant deflation of the outfit. The quick release air coupling connection can also be made separated (FIG. 23) as a female part 18 and male part 19.

The mechanical inflation trigger housings 17 are placed in a pocket 6 or under a cover in the outfit. The trigger housings (FIGS. 22-26) are triggered by using a retractable belt 8 from a belt-retractor 9 with emergency locking attached to a part of a motorcycle 10. The retractable belt 8 is instantly locked by the emergence locking when the rider is experiencing sudden movements and triggers the inflation (FIG. 25) when substantial force is applied to the locked belt that pulls out a trigger ball 5 from the mechanical inflation trigger housings. A metal piece 20 under pressure from a suspension 21 is released causing the metal piece to eject and pierce a hole 22 in the gas tank 14, inflating the outfit.

FIGS. 1, 22 illustrate trigger belts 7 connected via a multi-connector 11 to a part of a motorcycle 10. The multi-connector 11 enables multiple mechanical inflation trigger housings 17 to be connected and triggered simultaneously or with a delay.

The outfit further comprises inflatable boots (FIG. 20) with an electrical inflation trigger housing 23 on each boot. The electrical inflation trigger housings 23 inflates the boots by using chemical material that rapidly produces gas or fluid when ignited electrically. The trigger housings 23 have sensors measuring conditions from a ride to determine when to inflate. The electrical inflation trigger housing 23 on the right boot and left boot are interconnected wirelessly to exchange information 24 and make a more precise conclusion when to inflate. In an example, two or more garments needs to transmit a triggering signal for the outfit to inflate if multiple garments from the outfit have electronic inflation, in order to prevent unintentional inflation.

In a particular example, the electrical inflation trigger housings 23 use the rider's phone as a display and interface (FIG. 45). The trigger housings 23 send the measured conditions wirelessly (FIG. 21) to a software program in the phone 25 with relevant information about the outfit and the ride, such as speed and battery level information.

The current disclosure offers inflatable impact reducing protection for the majority of the lower body which includes the leg, pelvis, knee, thigh and hip.

Accordingly, several objects and advantages of my disclosure are to eliminate or mitigate one or more deficiencies in prior art, singly, or in any combination, and solves at least one of the problems of prior art by providing a system of an inflatable motorcycle outfit and methods of constructing the outfit.

A particular object is to solve the impact issue for the lower body by offering an airtunnel shell 13 with an airtunnel 12 adapted to fit inside a pair of trousers. The airtunnel shell 13 overlays the areas around the hips, the knees, the waist, the pelvis, the butt, the upper back legs, the upper front legs and the outer-sides of the entire legs when worn by a rider.

Yet another object is to solve the impact issue for the upper limbs and lower limbs by offering airtunnel shells 13 constructed in a manner that fits the limbs in the outfit, such as inside the arm of a jacket or the leg of a trouser. By using an intermediate (i.e., middle) material 31 (FIGS. 37-40, 42-44) stitched, or attached by heat, in-between the bottom material 43 and the top material 42 of the airtunnel shells 13. The intermediate material 31 enables the width of the airtunnel shells 13 to decrease 32 and the height to increase 33, without effecting the required air volume for the impact reducing properties. A reduced width of the airtunnel shells 13 enables the airtunnels 12 in the outfit to fit the limbs of the body. Further, the intermediate material 31 enables the airtunnel shells 13 to have a predetermined shape when inflated.

Another object is to solve the impact issue for the arms by constructing an airtunnel shell 13 with an airtunnel 12 that overlays part of the front and rear arms and the outer-sides of the entire arms, from the shoulders to the hands, further, around the connection between the hand and the lower arm (FIG. 10).

Another object is to solve the impact issue for the feet by providing inflatable, impact reducing motorcycle boots 4 (FIGS. 17-20). The boots 4 have an airtunnel for each boot 12 overlaying the top, the back, the outer-side, the inner side of the foot and part of the lower leg. The airtunnels 12 inflates by two interconnected electrical inflation trigger housings 23 located on each boot 4 in the event of an accident.

Another object is to offer impact reducing protection for the right and left side of the head by construction the inflatable canopies 35 for the vest 3 in a “C” shape 38 next to the head. The inflatable canopies 35 offers impact reducing protection if the head is slugged sideward in an accident situation.

Another object is to construct the airtunnel-canopies 35 (FIGS. 13-16) as a continuous airproof airtunnel from the upper body to the edges of the canopy structures 35. The construction enables the inflatable canopies to deploy with gas or fluid without any regards to wind circumstances or the speed and orientation of the rider when deployed in an accident situation. The airtunnel-canopies 35 are worn as a vest 3 uninflated, when inflated the airtunnel shell 13 expands outwards. The inflated airtunnel shell 13 expands upwards, vertically passing on the right and left side of the head, continuing upwards to form the wind catching canopy structures (FIG. 13-15). The airtunnel-canopies 35 provide impact reducing protection for the armpit area, the shoulders, the upper front torso, the upper back torso and the right and left side of the head in the event of an accident.

Another object is to reduce the impact speed of a rider in a motorcycle accident by offering an inflatable vest 3 with one or more inflatable canopies 35 (FIGS. 13-16) that rapidly deploys with gas or fluid in the event of a motorcycle accident. The gas or fluid expands to the edges of the canopy structures (FIG. 14) for full deployment when inflated. The inflatable canopies 35 will be referred to as airtunnel-canopies 35 or vest 3.

Another object is to attach the canopy suspenders 36 on the airtunnel-canopies 35 above the head of the rider.

Another object is to provide an elastic shock dampening solution 37 to absorb the force from the wind catching canopies 35 when deployed. The shock dampening solution is located above the shoulders and makes the airtunnel structure to form a “C” shape 38. The construction enables for enduring elastic ribbons (or any elastic material) 39 to be attached between the horizontal “C” shaped lines. The shape of the airtunnel-canopies 35 can thus be stretched out into a straight line and retract back to its original shape thanks to the enduring elastic ribbons 39. Relieving the body from an instant and abrupt force when the airtunnel-canopies 35 are deployed. The enduring elastic ribbons 39 relieve the body from some of the abrupt force without reducing the overall wind stopping force. The solution enables the airtunnel-canopies 35 to be connected through the “C” shaped construction 38, so gas or fluid can travel through the airtunnel-canopy 35 from the upper body to the edges of the canopy structures (FIG. 14).

Another object is to gather the stopping force from the airtunnel-canopies 35 around the armpit area of the upper body. The impact absorbing properties the inflated airtunnel-canopies 35 have reduces the abrupt stopping force absorbed by the armpits, to reduce the force additionally chock absorbing material 40 can be attached on the airtunnel-canopies 35 running under the armpits.

Another object is to create a new abrasion and heat resistant material (FIGS. 30, 31) for the construction of the airtunnel shells 13 the airtunnels 12 are placed in. The new material is referred to as mo'cycle airtunnel material herein (a play on words including my first name, Moses, combined with motorcycle). The term “mo'cycle airtunnel material” is only one embodiment, and does not otherwise limit my disclosure to a specific material.

Another object is to create the mo'cycle airtunnel material with abrasion and heat resistant properties in a single mono-layer (FIGS. 30, 31). The mo'cycle airtunnel material protects the vulnerable airtunnels 12 in the outfit from holes caused by abrasion, impact or friction heat in a motorcycle accident situation.

Another object is to create a new abrasion resistant and stretchable material 55 (FIGS. 27-29) for the outfit. The stretchable material 55 enables inward inflation, meaning the airtunnels 12 can inflate and expand inside garments made from the stretchable material 55 outwards. The stretching and expanding of the stretchable material 55 prevent pressure injuries that otherwise can occur if the airtunnels 12 inflates and the material does not stretch. The stretchable material 55 requires high stretch properties and have abrasion resistant properties. The stretchable material 55 comprises technical fibres in combination with natural fibres (FIGS. 28, 29). The stretchable material 55 is referred to as mo'cycle denim or mo'cycle denim material and resembles regular denim material in its look and structure. Like “mo'cycle airtunnel material,” the term “mo'cycle denim” is one I have coined, and is used herein to refer to one particular embodiment of my disclosure, and does not otherwise limit my disclosure to a specific material.

Another object is to construct the airtunnel shells 13 for the upper body (FIG. 10) and the lower body (FIG. 4) in a manner that makes the airtunnel shells 13 stretchable and self-contained when worn. The airtunnel shells 13 are self-contained and stretchable by elastic ribbons 41 connecting the airtunnel shells around a body part. Belt buckles, zippers, buttons or similar devices can additionally be used to connect the airtunnel shells 13 around the waist of the body. The airtunnel shells 13 can thus be worn by itself without a lining, a trouser or a jacket to be attached on.

Another object is to solve the heat and ventilation issue by constructing ventilation holes 27 in the airtunnel shells 13 in the outfit (FIGS. 4, 5, 6, 10). The ventilation holes 27 can be closed 28 with Velcro® 30, buttons or similar devices together with a cover 29.

Another object is to design the outfit in a manner resembling regular clothing (FIGS. 2, 3, 11, 16, 17) by hiding the airtunnels 12 inside airtunnel shells 13 in the outfit. The outfit can thus be used in social environments were apparel such as jeans are acceptable to wear.

Another object is to fulfil the long-felt desire to ride in impact reducing motorcycle jeans (FIGS. 2, 3) that resembles regular jeans by attaching an airtunnel shell 13 with an airtunnel 12 inside a pair of stretchable and abrasion resistant jeans 1.

Another object is to design the speed reducing airtunnel-canopies 35 as a garment resembling a vest 3, a jacket and/or a backpack (FIG. 16).

Another object is to construct the trouser 1 (FIG. 2, 3) and the jacket 2 (FIG. 11) so the garments can be interchangeable. By constructing the garments so the airtunnel shells 13 can be detachable with devices such as zippers 61, Velcro® 61 and/or buttons 53. The trouser 1 and jacket 2 can thus be machine washed separately without the airtunnel shells 13 with airtunnels 12 on the inside.

Another object is to eliminate the separation-distance issue that delays the vital inflation time in an accident situation by offering a mechanical (FIGS. 22-26) or electrical (FIG. 20) inflation trigger housing that inflates by sudden movements followed up by force or by measuring conditions with sensors and sending electronic triggering signals.

Another object is to solve the deflation issue so the rider manually can deflate garments in the outfit instantly after an accident situation. By releasing the gas or fluid tank 14 via a quick release air coupling (FIGS. 23-26).

Another object is to make a more precise conclusion when to inflate the outfit by interconnecting two or more electrical inflation trigger housings 23 wirelessly to each other, exchanging information 24.

Another object is to provide the rider with information regarding the rider's ride and the outfit via one or more electronic inflation trigger housings 23 (FIG. 21). The electrical inflation trigger housings 23 measures conditions from the ride and sends relevant information wirelessly 24 to a software (FIG. 45) in the rider's phone 25.

Another object is to use a phone 25 as display and interface for the electrical inflation trigger housings 23. The phone 25 requires a phone software (FIG. 45) in communication 24 with one or more electrical inflation trigger housings 23. The software enables the rider to time himself or herself on a racetrack, showing the best lap times, compare laps, show speed information, play a motorcycle game and enable the rider to directly purchase product from the software. The phone software can illustrate the rider's path and build a digital race track map based on the rider's path.

Another object is to illustrate the outfit in the phone software (FIG. 45) with the garments in use from the outfit highlighted with battery level information.

Further objects and advantages of my disclosure will become apparent from a consideration of the drawings and subsequent description.

### BRIEF DESCRIPTION OF THE DRAWINGS

FIG. 1 is a side view of the embodiment of the outfit, illustrating the outfit with inflatable jeans, inflatable jacket, inflatable vest and inflatable boots, flat and uninflated.

FIG. 2 is a front, back and side view of the embodiment of the inflatable jeans in the system, illustrating the airtunnel shell for the lower body underneath.

FIG. 3 is a front, back and side view of an embodiment of the inflatable trouser in the outfit. The trouser is made from two stretchable materials in the outer shell of the trouser. Knitted material is used in on the outer sides of the legs and the inside of the lower legs.

FIG. 4 is a front, back and side view of the uninflated airtunnel shell for the lower body, illustrating the airproof airtunnels underneath.

FIG. 5 is a front, back and side view of the inflated airtunnel shell for the lower body, illustrating the airproof airtunnels underneath.

FIG. 6 is a front view of an embodiment of the inflatable trouser with the airtunnel shell constructed as a trouser with outward inflation.

FIG. 7 is a front view of an embodiment of the inflatable trouser with the airtunnel shell constructed as a trouser with outward inflation and without any ventilation holes.

FIG. 8 is a view from above of the airtunnel shell for the lower body spread out.

FIG. 9 is a view from above of the jean patterns, illustrating a zipper part in the waist of the jean to attach an airtunnel shell.

FIG. 10 is a front, back and side view of the embodiment of the airtunnel shell for the upper body, illustrating the inflated airproof airtunnel inside.

FIG. 11 illustrates two front views of the embodiment of the inflatable jacket in the system. The image to the left illustrates the airtunnel shell for the upper body inflated and the image to the right illustrates the airtunnel shell inside the inflatable jacket.

FIG. 12 is a front view of an embodiment of an inflated jacket with outward inflation.

FIG. 13 is a front view of the embodiment of the inflated airtunnel-canopy.

FIG. 14 is a side view of the embodiment of the inflated airtunnel-canopy.

FIG. 15 is a rear view of the embodiment of the inflated airtunnel-canopy.

FIG. 16 is a front and rear view of the embodiment of the uninflated airtunnel-canopy, folded as a garment resembling a vest.

FIG. 17 is a perspective view of the embodiment of the uninflated boots with the excess airtunnel shell material folded and buttoned down.

FIG. 18 is a perspective view of an embodiment of the uninflated boots with the excess airtunnel shell material folded multiple times and buttoned down.

FIG. 19 is a perspective view of the inflated boots.

FIG. 20 includes back, front and side views of the embodiment of the inflated boots.

FIG. 21 includes four front views of the inflated airtunnel shells for the lower body, upper body, airtunnel-canopy and the feet in the system.

FIG. 22 is a representative illustration of how the mechanical inflation trigger housing, trigger belts, trigger balls, multi-connector, retractable belt, belt-retractor and the connection to the motorcycle are connected to each other.

FIG. 23 is a side view of the embodiment of the mechanical inflation trigger housing. Illustrating the embodiment of the tank with a male quick release air coupling connection and the inflation trigger housing with a female quick release air coupling connection.

FIG. 24 is a cross-section view from the side of the mechanical inflation trigger housing, illustrating a metal piece under pressure from a suspension and held in place by a trigger ball with a trigger band connected to it.

FIG. 25 is a cross-section view from the side of the mechanical inflation trigger housing, illustrating the trigger ball pulled out of the mechanical inflation trigger housing, releasing the suspension that has ejected a sharp metal piece upwards, creating a hole in the tank that inflates an airtunnel.

FIG. 26 is an embodiment of the quick release air coupling connection made as two separated pieces that can connect to a tank and a mechanical inflation trigger housing.

FIG. 27 is a view from above of an embodiment of the mo'cycle denim material weaved as a 2/1 twill.

FIG. 28 is a representative view of the yarn composition in the weft direction of the mo'cycle denim material with two technical fibres in the core with one natural fibre covering the core.

FIG. 29 is a representative view of the yarn composition in the warp direction of the mo'cycle denim material with one technical fibre in the core and one natural fibre covering the core.

FIG. 30 is a view from above of the embodiment of the mo'cycle airtunnel material weaved with a 1/1 twill.

FIG. 31 is a representative view of the yarn composition in the warp direction of the mo'cycle airtunnel material with one technical fibre in the core and one technical fibre covering the core.

FIG. 32 is a representative view of the embodiment of material layer composition for the system with inward inflation. From outside, a stretchable and abrasion resistant material towards the impact side, a heat and abrasion resistant material as the top material of the airtunnel shell, a material with tensile strength to withstand an inflation as bottom material for the airtunnel shell, the human body.

FIG. 33 is a representative view of an embodiment of material layer composition for the system with inward inflation. From outside, a stretchable material towards the impact side, an abrasion resistant material as the top material of the airtunnel shell, a material with tensile strength to withstand an inflation as bottom material for the airtunnel shell, the human body.

FIG. 34 is a representative view of an embodiment of material layer composition for the system with outward inflation. From outside, an abrasion resistant material as the top material of the airtunnel shell towards the impact side, a material with tensile strength to withstand an inflation as bottom material for the airtunnel shell, the human body.

FIG. 35 is a view from above and the side of the construction of an airtunnel shell. Illustrating top, middle and bottom material.

FIG. 36 is a representative view of the embodiment of how the airtunnel shells are closed with stitching, for example.

FIG. 37 is a front view of an embodiment of an airtunnel shell with an airproof airtunnel inside, using two intermediate (i.e., middle) materials for constructing the airtunnel shell.

FIG. 38 is a front cross section view of an embodiment of an airtunnel shell with an airproof airtunnel inside, illustrating the airtunnel shells construction with two intermediate materials.

FIG. 39 is a front view of the embodiment of an airtunnel shell with an airproof airtunnel inside, using one intermediate material for constructing the airtunnel shell.

FIG. 40 is a front view of a cross section of an embodiment of an airtunnel shell with an airproof airtunnel inside, illustrating the airtunnel shells construction with one intermediate material.

FIG. 41 is a front view of an embodiment of two uninflated airtunnel shells stitched together in the middle.

FIG. 42 is a front view of an embodiment of two inflated airtunnel shells stitched together in the middle, illustrating that the airtunnel shells were attached together with Velcro® and buttons, as examples.

FIG. 43 is a front, side and above view of an embodiment of an airtunnel shell constructed without an intermediate material, illustrating the wide width when an intermediate material is not used.

FIG. 44 is a front, side and above view of the embodiment of an airtunnel shell constructed with an intermediate material, illustrating how the width is reduced and height is increased when using the middle intermediate in the construction of the airtunnel shells.

FIG. 45 is a chart of how the electrical inflation trigger housing is connected to the phone software and the options in the phone software.

FIG. 46 is a front view of an embodiment of two uninflated airtunnels 12 with a top fabric 63 and a bottom fabric 64 stitched on the airtunnel shells 13, covering the middle seam 65 said airtunnels 12 are attached with.

FIG. 47 is a front view of an embodiment illustrating how the top fabric 63 and bottom fabric 64 becomes a barrier, an inflatable protector, against impact force when the airtunnels 12 are inflated. Once the airtunnels 12 are inflated the top fabric 63 and bottom fabric 64 are stretched out and becomes hard due to the pressure from the inflation.

FIG. 48 is a top view of an embodiment of the arrangement of FIGS. 46 and 47.

FIG. 49 is a top view of another embodiment of the arrangement of FIGS. 46 and 47.

FIG. 50 is a top view of yet another embodiment of the arrangement of FIGS. 46 and 47.

### DETAILED DESCRIPTION

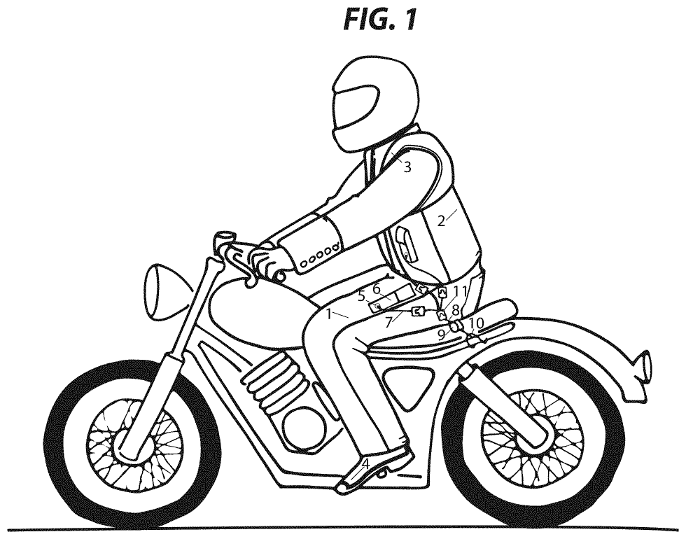

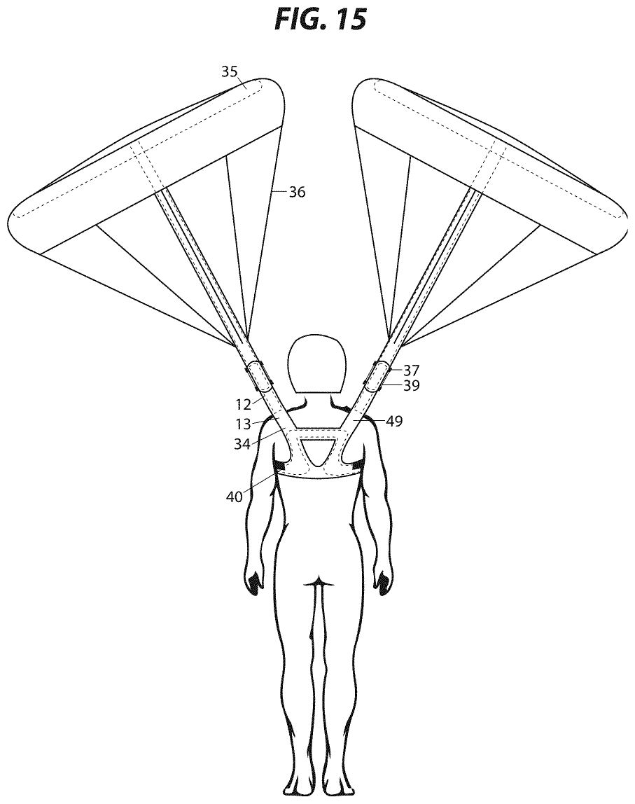

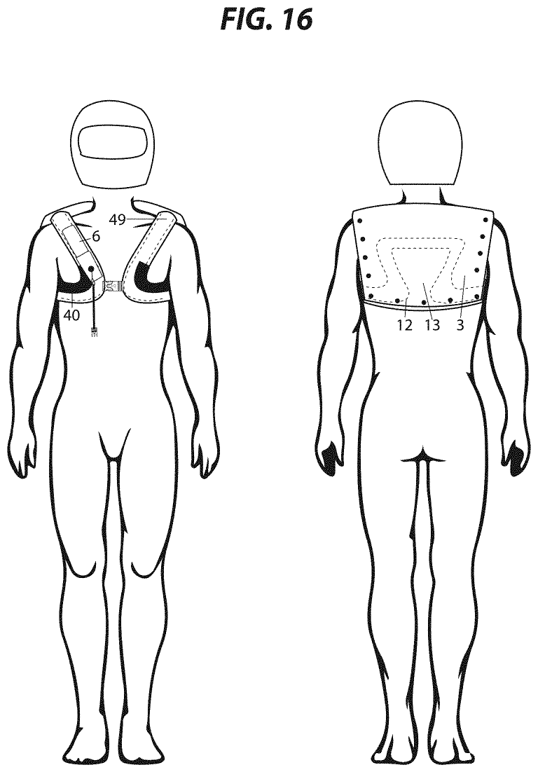

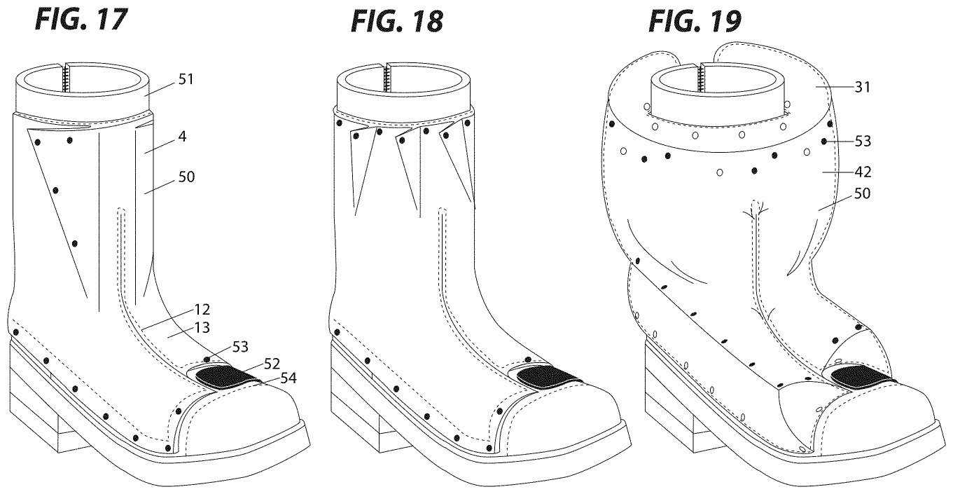

This disclosure relates to a system of an inflatable motorcycle outfit (FIGS. 1, 2, 3, 6, 7, 11, 12, 16, 17, 18, 21) and methods of constructing the outfit. Reference is made to various representative figures in parentheticals, such as to the outfit (FIG. 1), but reference to a particular figure is not limiting, and is done only for purposes of explaining a representative example.

The outfit, in one example, comprises an airtunnel 12 with an airtunnel shell 13 for a trouser 1, an airtunnel 12 with an airtunnel shell 13 for a jacket 2, an airtunnel 12 with an airtunnel shell 13 for a vest 3 with one or more inflatable canopies 35, and airtunnels 12 with airtunnel shells 13 for boots 4.

The airtunnels 12 are located inside the airtunnel shells 13 inside, outside or arranged together a garment. The airtunnels 12 arranged with the airtunnel shells 13 are referred to as airtunnel structure or airtunnel structures.

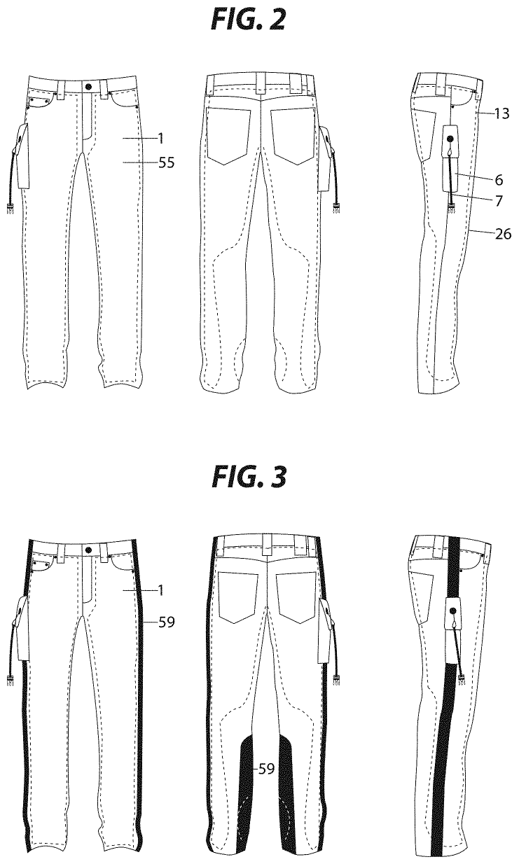

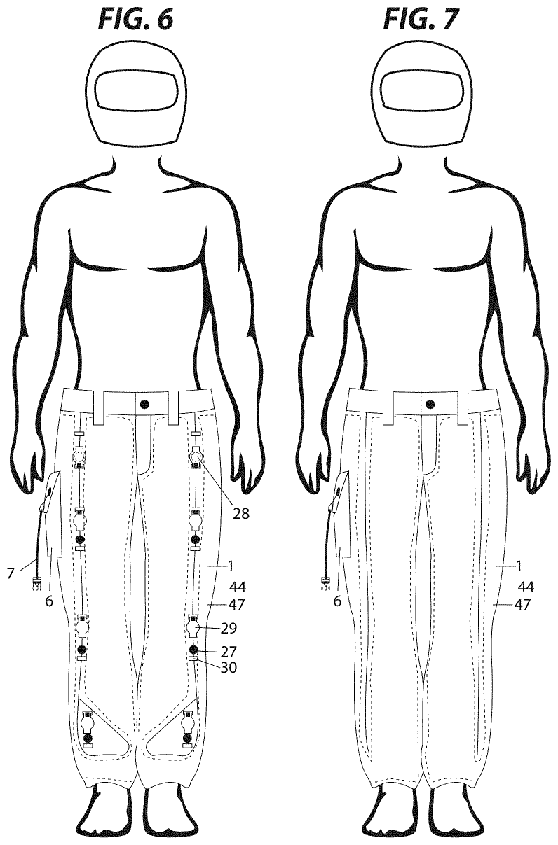

Each airtunnel 12 in the outfit have its own airtunnel shell 13, constructed to fit for outward inflation (FIGS. 6, 7, 12, 16, 17) and/or inward inflation (FIGS. 2, 3, 4, 5, 11) to offer impact, abrasion and/or speed reducing properties.

The airtunnels 12 are made from an airproof material with a mechanical or electrical inflation trigger housing 17, 23 attached to the airtunnels 12.

The airtunnels 12 are rapidly inflated with gas or fluid in a motorcycle accident situation. The airtunnel shells 13 determines the shape of the inflated airtunnels 12, further, protects the airtunnels 12 from impact, heat and abrasion forces from a motorcycle accident situation.

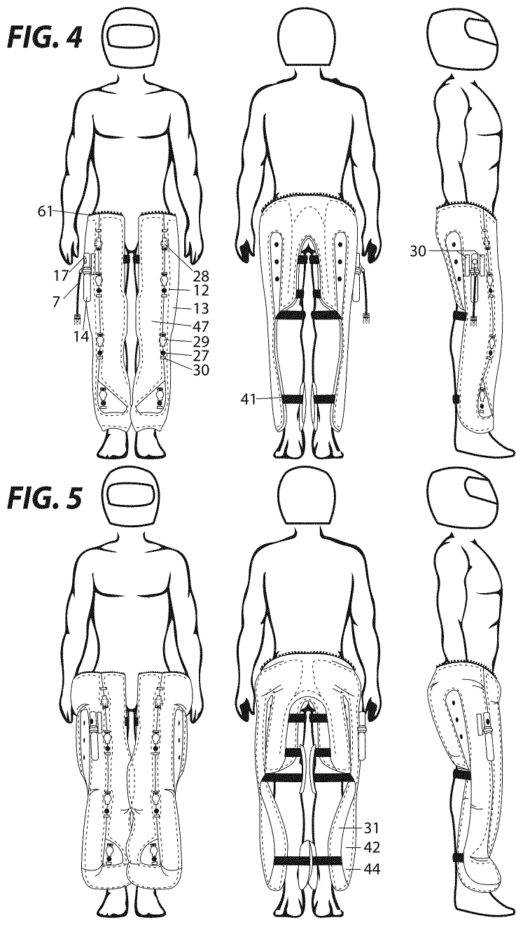

The system comprises an airtunnel structure for the lower body 47 (FIGS. 4, 5, 8). The structure 47 has airtunnels running on the outer-sides of the legs, the front of the legs, around the waist and the rear part of the legs covering the butt area.

The physical structure of the airtunnel for the lower body 47 is spread-out and overlays the areas around the hips, the knees, the waist, the pelvis, the butt, the upper back legs, the upper front legs and the outer-sides of the entire legs, when worn by the rider (FIGS. 4, 5).

The structure for the lower body 47 overlays the upper leg on the front, the back and the outer-sides. The structure 47 does not cover directly behind the knees because of comfort and movability for the legs. The structure 47 further overlays the waist, which also covers the pelvis underneath, on the front, the rear and the outer-sides of the waist. The structure 47 overlays the butt area until the kneecap area, which also covers the pelvis underneath. The structure 47 further overlays the beginning of the spinal column on the lower rear part of the torso (FIGS. 4, 5).

For enhanced impact reducing protection, viscoelastic, soft or hard-shell protectors can be attached anywhere on the airtunnel shells 13 in the outfit, such as the kneecap area for example.

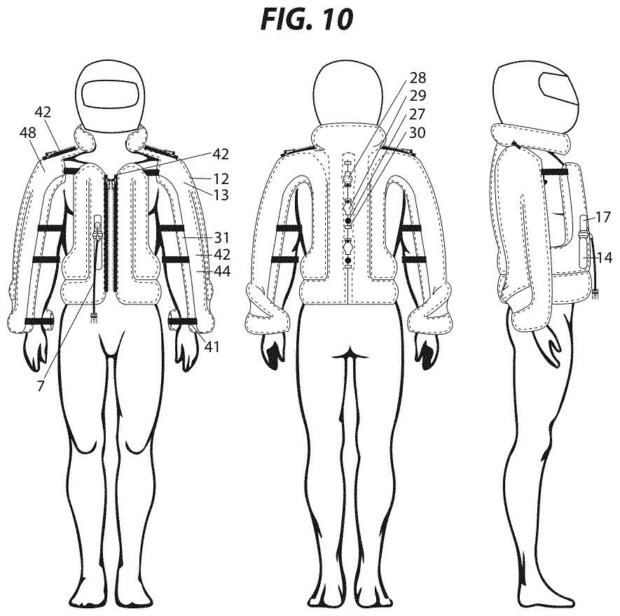

The system further comprises an airtunnel structure 48 for the upper body. The structure 48 is spread-out and overlays the areas around the neck, the front shoulder, the rear shoulder, the side of the shoulder, the chest, the upper abdominal, the lower abdominal, the side of the abdominal, the spinal column, the lower back, the rear of the ribs, the outer-side of the arm, the elbow on the front, side and rear and around the hand wrist, when worn by the rider (FIG. 10).

The airtunnel structure 48 for the upper body 37 has airtunnels running on the entire outer-side, part of front and back of the arms, from the shoulders to the hand wrist (FIG. 10). The construction of the physical airtunnel shell reduces injuries by overlaying areas on the upper body and the limbs that are exposed to impact forces in a motorcycle accident.

The airtunnel structures for the upper body 48 and lower body 47 are connected around the body with elastic ribbons 41. The elastic ribbons 41 makes the otherwise non-stretchable airtunnel structures stretchable and comfortable to wear.

The system further comprises an airtunnel structure 49 for the inflatable canopies (FIGS. 13-16). The structure 49 is folded and located around the armpits and on the upper rear part of the back torso. The structure 49 resembles a vest 3, a jacket, or a backpack when worn by the rider and inflates in the event of an accident.

In an accident situation, gas or fluid rapidly expands the inflatable canopy structures 35 upwards and deploys the canopy structures 35 with high pressured gas or fluid. The deployed canopy structures 35 rapidly catches the wind in a similar fashion as a parachute, and thus reduces the impact speed in an accident situation.

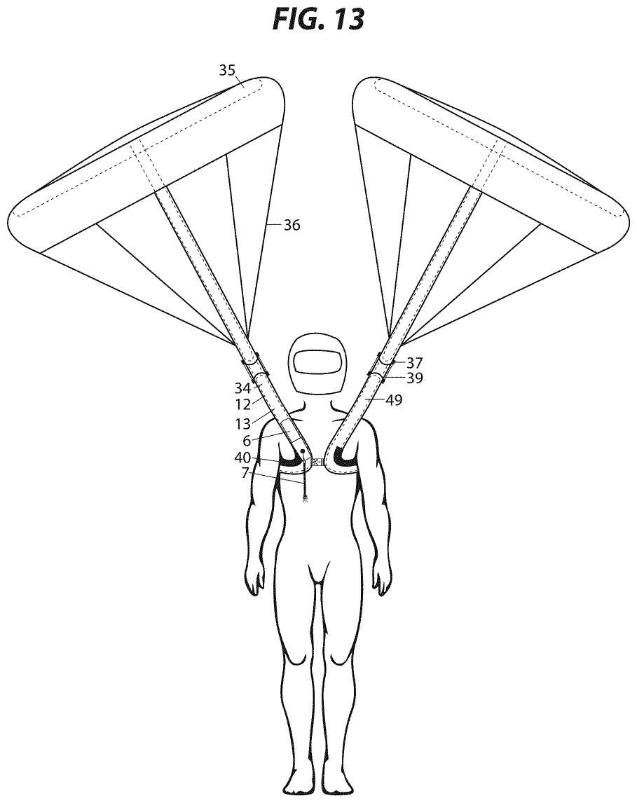

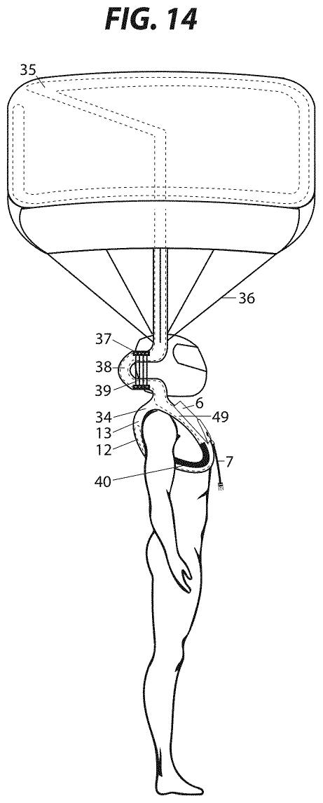

To reduce the abrupt stopping force the moment the canopy structures 35 are deployed and catches the wind, a damper 37 with elastic, resilient material 39 is created above the shoulders and below the canopy structures 35. By constructing a part of the airtunnel-canopies 49 in a “C” shape 38, elastic and enduring material 39 can be attached between the horizontal lines in the “C” shaped construction (FIG. 14). The shape of the airtunnel structure 49 can thus be stretched out into a straight line and retract back to its original shape, relieving the body from an instant and abrupt force when the canopy structures 35 are deployed. The elastic, resilient material 39 absorbs the abrupt force without reducing the overall stopping force from the canopy structures 35. The construction enables the airtunnel-canopies 49 to be connected so the canopy structures 35 can be deployed with gas or fluid.

The “C” shape 38 shock dampening construction on the left and right side of the head offers impact reducing protection for the head if the head is slugged sideward in an accident situation (FIG. 14).

To further absorb energy from the wind catching canopies 35, the airtunnel shell 13 for the inflatable canopies can be made from stretchable material with relatively high tensile strength to resist the wind catching stopping force. The stretchable material further absorbs some of the wind stopping force.

The stopping force from the canopy structures 35 will eventually be absorbed by the armpit areas. Shock absorbing material 40 can reinforce the area around the armpit on the airtunnel-canopies 49 to further absorb energy. The airtunnel-canopies 49 will be inflated under the armpit and further absorb energy before the force reaches the muscles and skeleton.

The system further comprises two inflatable airtunnel structures 50 for the feet (FIGS. 17-20). The structures 50 inflate in the event of an accident by two electrical inflation triggering housings 23. The structures 50 are attached (e.g., stitched) on a pair of boots 4 comprising of an outer shell material 51, inner shell material, outer sole, inner sole, shank, heel shock, heel, abrasion resistant material 52, zipper, buttons 53, two electrical inflation trigger housings 23 and a phone software 25.

The boots have a flat, out-spread airtunnel shell 13 integrated in the design of the boots 4 as a part of the outer shell 51. The boots 4 are constructed as traditional boots and the airtunnel structures 50 are stitched on the outer shell 51 of the boots 4. The flat airtunnel shell 13 is buttoned down on the boots outer shell 51 (FIG. 17), when inflated (FIG. 19) the buttons 53 will release and allow the airtunnel structure 50 to expand outwards. The material for the airtunnel shell 13 can be made from mo'cycle airtunnel material 44 to withstand the abrasion and heat forces in an accident situation.

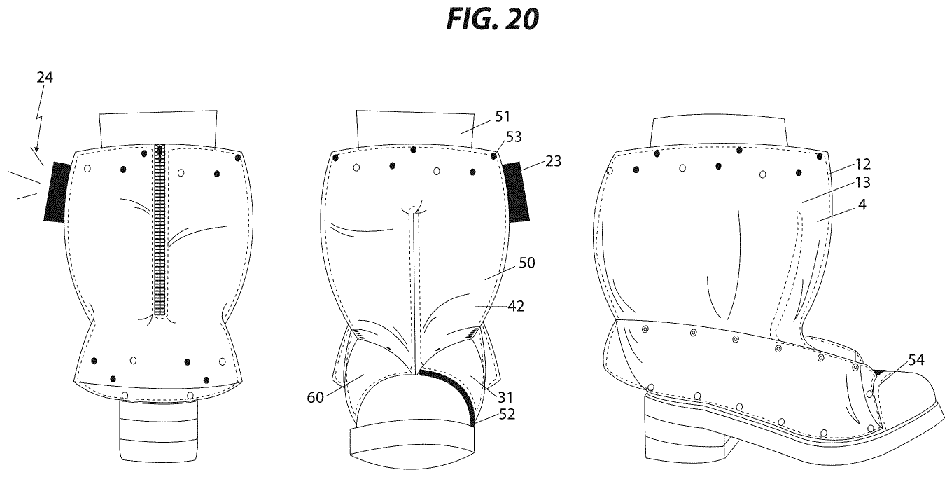

The boots 4 have airtunnels 12 overlaying the sides of the feet, the ankles, the top of the feet, the heel, the rear of the feet and part of the lower legs (FIG. 20).

The boots can have additional hard- or soft-shell impact reducing protectors overlaying specific areas of the boots, such as around the ankle area, the heel area and inside the boots around the toe area 54.

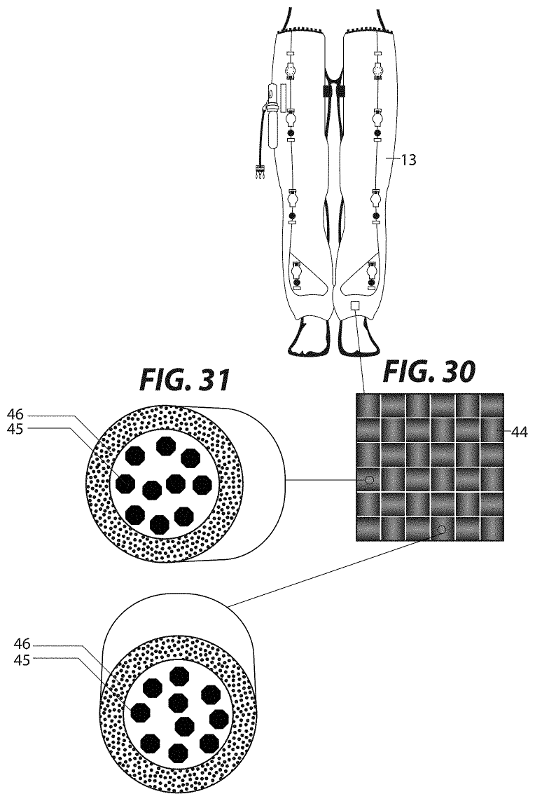

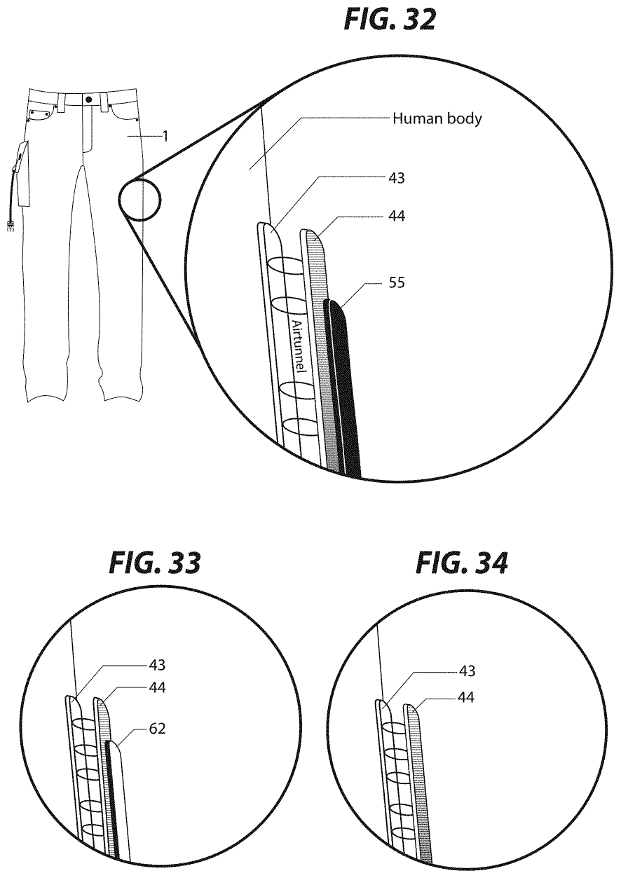

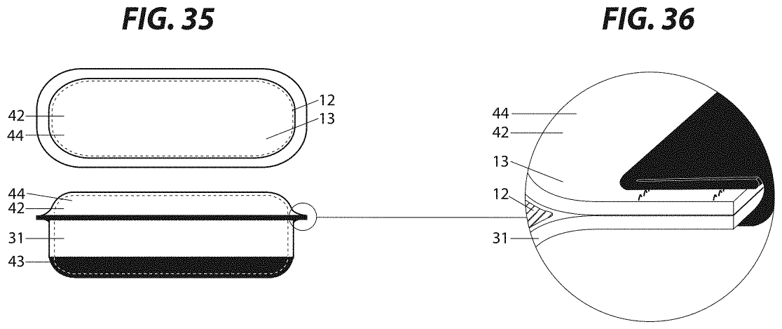

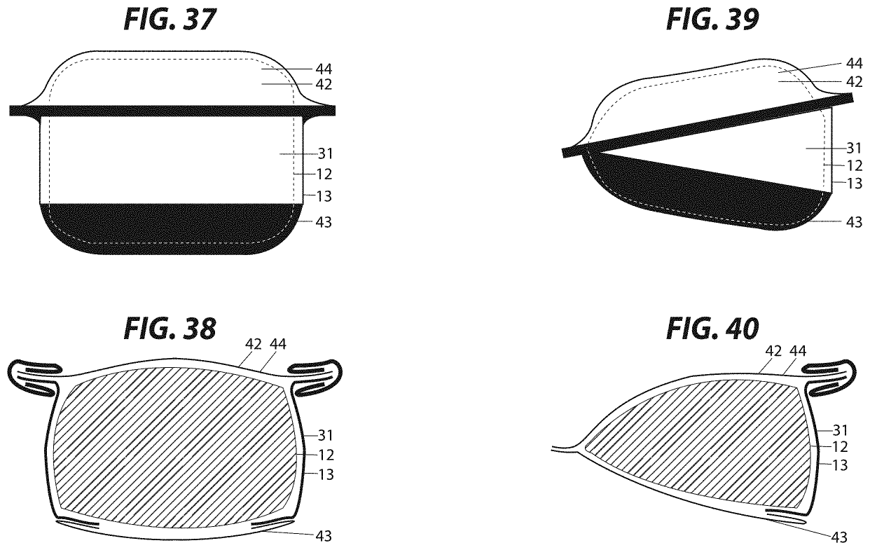

The airtunnel shells 13 in the outfit comprises a top material 42 towards the impact side in the event of a motorcycle accident. The top material comprises a new material referred to as mo'cycle airtunnel material 44 (FIGS. 30, 31). The mo'cycle airtunnel material 44 has abrasion and heat resistant properties to protect the airtunnels 12 from holes caused by abrasion, friction heat, or impact forces in a motorcycle accident. The mo'cycle airtunnel material also has relatively high tensile strength to withstand the rapid inflation when the outfit inflates. While this is one particular example material, this disclosure extends to other similar materials. In particular, the top material 42 can comprise mo'cycle airtunnel material 44 with abrasion and heat resistant properties or any other material that can withstand the rapid inflation without breaking apart. The mo'cycle airtunnel material 44 enables the top material 42 to work as a single layer of abrasion and heat resistant material to protect the inflatable airtunnels 12 and the body of the rider.

The yarn for the mo'cycle airtunnel material 44 is made from an abrasion resistant fibre 45 with long continuous filaments, such as ultra-high-molecular-weight-polyethylene (UHMWPE). The abrasion resistant fibre 45 is combined with a yarn or fibre 46 with a melting point above 100 degrees Celsius (212 degrees Fahrenheit) (FIG. 31) to obtain heat resistant properties. The abrasion resistant fibre and the heat resistant fibre can be mixed and spun into one yarn or core spun into one yarn. When the one yarn is obtained by core spinning the outer layer of the one yarn comprises abrasion resistant fibres 45 with long continuous filaments. The outer layer covers the visible area of the core of the one yarn. The core comprises a temperature resistant yarn or fibre 46.

The mo'cycle airtunnel material 44 is obtained by, in one example, weaving the one yarn as a 1/1 twill (FIG. 30) but can also be obtained by weaving a 2/1, 3/1, 4/1 or a 5/1 twill.

The mo'cycle airtunnel material 44 can be used as the top material for the airtunnel shells 13 towards the impact side in the event of a motorcycle accident. The combination enables for abrasion resistant properties and enhances the temperature resistance properties so the mo'cycle airtunnel material 44 can withstand more friction heat in an accident situation.

The yarn used to obtain the mo'cycle airtunnel material can further be made into a rope. The rope is referred to as mo'cycle rope herein, and can be used as canopy suspenders 36 and as belts used in the mechanical inflation trigger housings 17. The retractable belt 8, the belt loop, the multi-connector 11 and the trigger belts 7 can be made from the mo'cycle rope. The rope is able to resist weather conditions such as UV radiation and is safe to use due to its high tensile strength. The rope enables the belt-retractor 9 to be made in a small dimension because the rope can be obtained with a small radius, a thin rope with the desired properties.

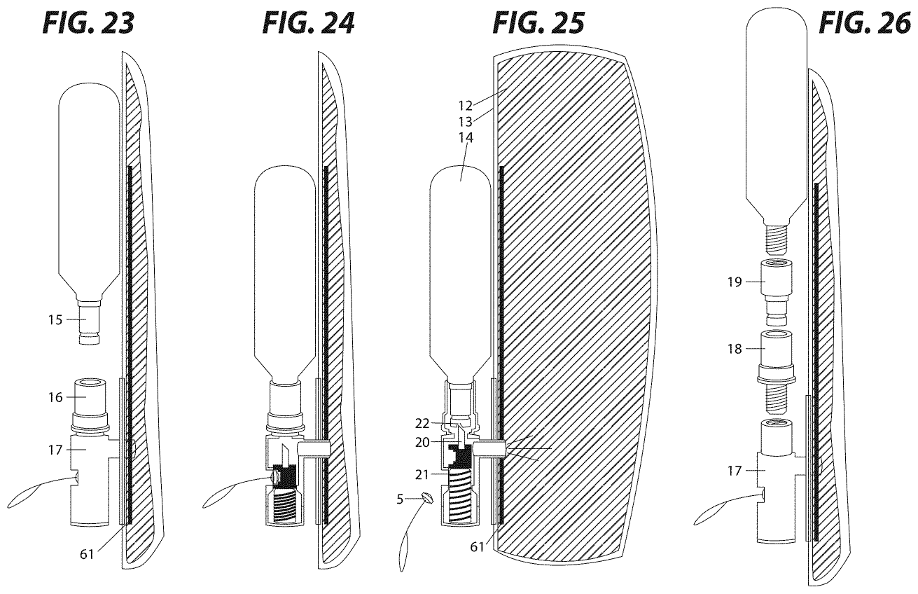

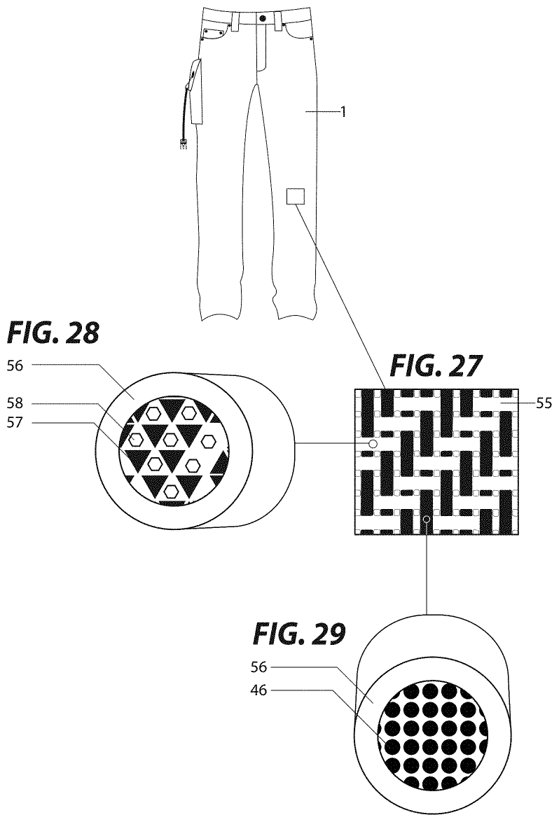

The system further comprises a new material referred to as mo'cycle denim material or mo'cycle denim 55, (FIG. 27). The mo'cycle denim 55 is used as the outer shell material for the trouser 1 (FIGS. 2, 3, 11) and the jacket 2 in the system. The mo'cycle denim 55 has high stretch properties to enable airtunnels 12 to inflate inwards without causing pressure injuries to the body. The mo'cycle denim material 55 also has abrasion resistant properties to reduce abrasion forces in a motorcycle accident situation.

The mo'cycle denim material 55 is used as the outer shell material which makes inward expanding inflation possible. Inward expanding inflation happens when the inflated airtunnel 12 presses inward on the body and stretches the outer shell material of a garment outwards. The advantages with inward inflation are that the airtunnel shells 13 for the system can completely be hidden inside a garment for design purposes. The mo'cycle denim material 55 further offers an additional layer of abrasion resistant protection for the inflatable airtunnels 12, the airtunnel shells 13 and the rider.

The warp yarn of the mo'cycle denim material 55 comprises an abrasion resistant fibre 46 with long continuous filaments such as UHMWPE, for example. The abrasion resistant fibre is combined with natural fibres 56 to resemble ordinary denim fabric (FIG. 29). The abrasion resistant fibre 46 and the natural fibre 56 are core spun with the natural fibre 56 covering the abrasion resistant fibre 46 to obtain the yarn for the warp direction. This combination makes the mo'cycle denim 55 abrasion resistant in the warp direction towards the impact side while the stretch properties comes from the yarn placed in the weft direction (FIG. 28), the horizontal direction towards the rider's body.

The weft yarn (FIG. 28) for the mo'cycle denim 55 comprises one or more stretchable fibres 57, a natural fibre 56, and an abrasion resistant fibre with short continuous filaments 58. The stretchable fibre can for example comprise elastane fibre that can stretch and retract up to 500% without losing any mechanical properties.

The stretchable 57 and abrasion 58 resistant fibres are mixed to one fibre mix and used as core for the yarn in the weft direction. The core is covered by the natural yarn and core spun into one yarn for the weft direction (FIG. 28).

The weft and warp yarns are combined into one material 55 by weaving (FIG. 27) or knitting. The material 55 will, in one embodiment, be obtained by weaving a 2/1 (FIG. 27) twill or a 3/1 twill as regular denim fabric is weaved. A 3/1 twill would result in 3 vertically aligned abrasion resistant yarns in the warp direction, the direction towards the impact side in the event of a motorcycle accident, connected by 1 horizontally aligned stretch yarn in the weft direction towards the body of the rider. A 2/1, 3/1, 4/1 twill obtains a traditional denim look, but the material can also be obtained by a 1/1 or 5/1 twill.

To obtain higher stretch properties for the limbs of the jacket 2 and trouser 1, (FIG. 3, 11) a new knitted material 59 will be obtained which have higher stretch properties than the mo'cycle denim material 55. The knitted material will be referred to as mo'cycle knitted material, although this term is not intended to limit this disclosure.

The fibre composition of the warp yarn of the mo'cycle denim 55 or the fibre combination of the warp yarn of the mo'cycle airtunnel material 44, can be knitted into one material. The knit structure determines the amount of stretch that is possible to obtain while the fibre combination makes the knitted material abrasion and/or heat resistant. The knitted material can be combined with the mo'cycle denim 55 in the outer shell of the trouser 1 and jacket 2 in the system.

The mo'cycle denim material 55 enables airtunnel structures to expand inside garments made from the mo'cycle denim 55, and further has the abrasion resistant properties required in a motorcycle accident situation, while resembling a traditional denim look.

The mo'cycle denim material 55 can be composed by other fibres than the ones mentioned above. The stretch property allows for a suitable outer shell material for inward inflation for the garments in the system. The required stretch properties depend on the fit of the garments, a wide fit requires less stretch and vice versa.

The airtunnel shells 13 in the outfit are constructed with a top material 42, an intermediate material 31 and a bottom material 43.

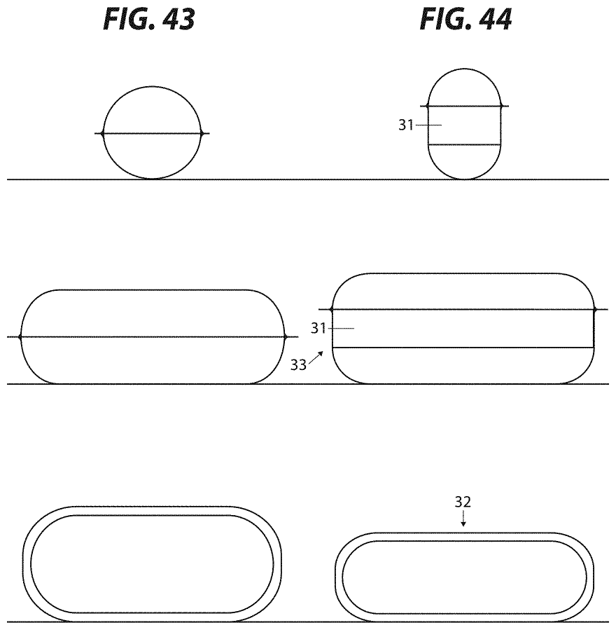

The use of an intermediate material in the airtunnel shells 13 reduces the width 32 and increases the height 33 of the airtunnel shells 13 (FIG. 43, 44) without effecting the air volume required for the impact reducing protection.

The intermediate material 31 enables the airtunnel shells 13 to fit inside the legs of a trouser or the arms of a jacket, further enables the airtunnels 12 for the boots 4 (FIG. 19) to obtain the required air volume, and also enables the airtunnel shells 13 to have a pre-determined shape when inflated (FIG. 19). The intermediate material 31 can be cut in a rectangular or triangular shape 60 before being stitched to the top 42 and bottom 43 material.

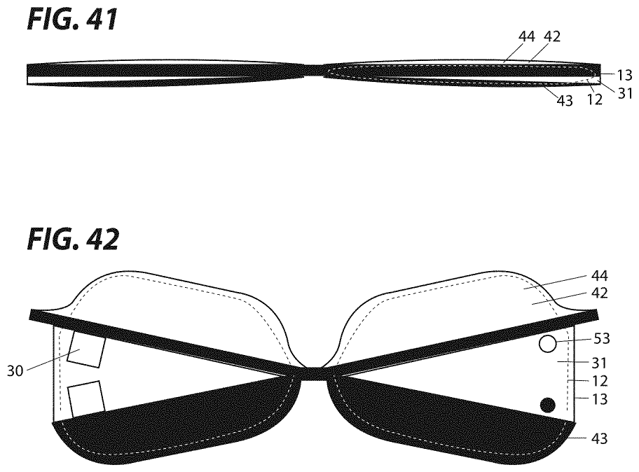

The intermediate material 31 is folded and fastened with buttons 53, Velcro® 30, and/or stitched with stitches that can break apart (FIG. 41, 42). When the airtunnels 12 are inflated the buttons 53, Velcro® 30 and/or the stitches will break open by the inflation force (FIGS. 41, 42), enabling more space for the airtunnels 12 to expand.

The intermediate material 31 can be attached between the bottom material 43 and the top material 42 by stitching and/or heat pressing. The intermediate material 31 and bottom material 43 can be made from a tensile strong material that can withstand the rapid inflation.

The top material 42, the bottom material 43 and the intermediate material 31 can be composed by other fibres than the ones mentioned. The tensile strength can withstand an inflation. The abrasion and heat properties of the top material 42 protect the inflatable airtunnels 12 against holes and to protect the rider's body.

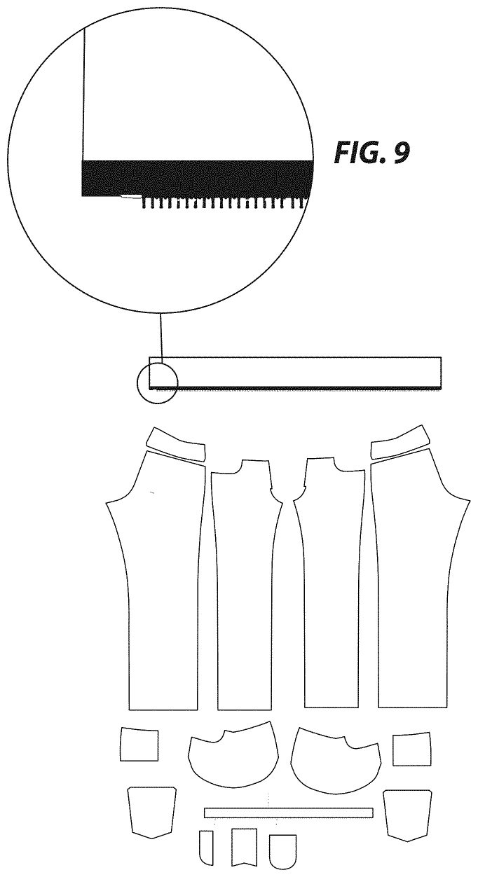

The system further comprises a pair of trousers 1 (FIGS. 2, 3) comprising of stretchable and/or abrasion resistant weaved material, stretchable and/or abrasion resistant knitted material, a zipper-part (FIG. 9), buttons, rivets, fly, pockets, pocket lining and a pocket or a cover 6 for the mechanical 17 or electrical inflation trigger housing 23.

The long lifespan of the trouser 1 constructed with the mo'cycle denim material 55 enables long-term colour-fading, which is desired by denim fans. The trouser 1 without an airtunnel shell 13 zipped inside, can be used as fashion jeans for non-riders, the high stretch properties enable comfort and the abrasion resistant properties increases the life span of the trouser 1 with many years, reducing the need to buy new trousers and thereby helping save the environment.

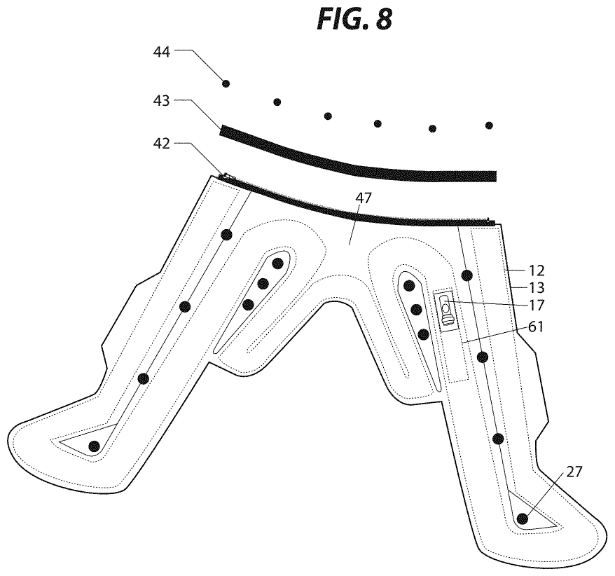

The waist of the airtunnel shell 13 for the lower body 47 has a zipper-part 42 stitched to it (FIG. 8), the waist of the trouser 1 has the other zipper part stitched to it (FIG. 9). The airtunnel can easily be zipped in and out of the trouser 1 in the system.

The zipper 42 can be replaced with other attachments such as buttons and the like (FIG. 8). The airtunnel shell 47 can also be stitched directly into the waist of the trouser 1 but then the washing of the apparel would become difficult.

The zipper 42 enables the trouser 1 to be washed without the airtunnel shell 47 and allows the rider to interchange the trouser 1 with new models compatible with the airtunnel shell 47. The zipper 42 enables the rider to choose how to wear the outfit depending on the social situation and other factors. All options on how the outfit is worn have its advantages and disadvantages with regards to the level of protection, comfort, and style.

The embodiment is to use the outfit with the airtunnel structure for the lower body 47 hidden inside of the trouser 1. This enables for abrasion and impact reduction and while the outfit can be used in social situations were regular looking jeans or trousers are accepted. Riding a motorcycle in jeans has long been an unfulfilled desire among many riders, the outfit finally offers a system that allows riders to have both impact reducing and abrasion reducing protection, covering most of the lower body when riding in jeans 1.

The outfit further comprises a stretchable and/or abrasion resistant jacket 2 comprising of stretchable and/or abrasion resistant weaved material, stretchable and/or abrasion resistant knitted material, buttons, zipper, pockets, pocket lining and a pocket 6 or a cover for a mechanical 17 or electrical inflation trigger housing 23.

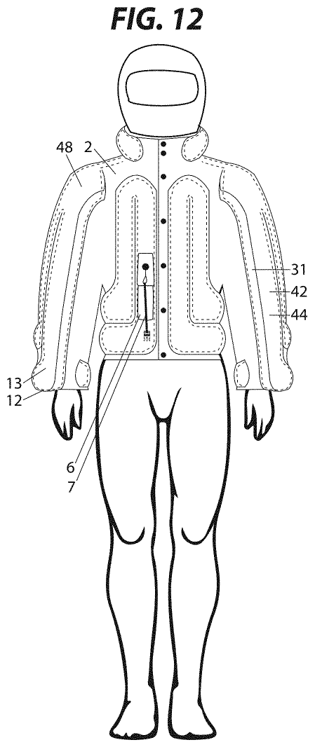

The trouser 1 and jacket 2 can also be constructed without stretchable material, but in that case the design would have to be made with outward expanding inflation (FIG. 12). The outer shell material of most standard garments is not required to be stretchable with outward expanding inflation.

The jacket's 2 outer shell can be made from mo'cycle denim 55 to fulfil the stretch requirements for inward inflation and to obtain an additional layer of abrasion protection. The jacket 1 can have additional stretchable material combined in the outer shell, such as knitted stretchable material to obtain more stretch properties.

The airtunnel structure for the upper body 48 is attached with buttons, zippers 42, Velcro® 30, and/or other suitable attachments inside a stretchable jacket 1 that allows for inward inflation.

The airtunnel shell for the upper body 48 can easily be removed from the jacket 2 and washed separately when required. The rider can also interchange the jacket 2 when new jacket models compatible with the airtunnel shell 48. The airtunnel shell 48 can also be stitched directly into the jacket but would make the washing difficult. The detachable construction enables the rider to choose how to wear the outfit depending on social situations. All options on how the outfit is worn have its advantages and disadvantages when it comes to level of protection, comfort, and style.

One embodiment is to use the outfit with the airtunnel structure for the upper body 48 hidden on the inside the jacket 2, which offers abrasion and impact reducing protection and at the same time the system can be used in social situations were a regular looking jacket is accepted.

The jacket 2, without the airtunnel shell inside 48, can be used as a fashion jacket for non-riders, the high-stretch properties enable comfort and the abrasion resistant material increases the life span of the jacket 2 with many years, reducing the need to buy new jackets and saving on the environment.

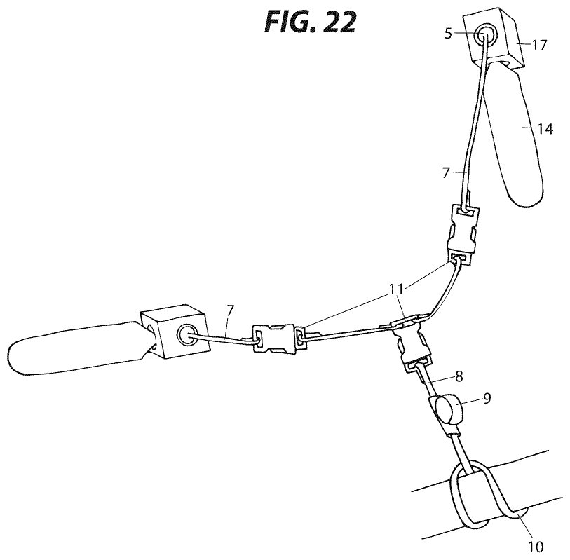

The outfit further comprises one or more mechanical inflation trigger housings 17 with inflation gas such as compressed gas or fluid 14 (FIGS. 22-26).

The mechanical inflation trigger housings 17 have a quick release air coupling connection 15, 16 for the gas or fluid tanks 14 to attach on. The quick release air coupling (FIG. 23) enables the tanks 14 to quickly be removed from the trigger housings 17 after an accident situation to instantly deflate the outfit. It is important to be able to deflate the outfit after an accident situation if the medical team needs to threat injuries.

The gas or fluid tank 14 has a tank head constructed as a male part 15 of the quick release air coupling connection. The mechanical inflation trigger housing 17 has the trigger housing constructed as a female part 16 of the quick release air coupling connection. The tank 14 and the trigger housing 17 can thus be connected to each other with an airtight connection.

In one example, each mechanical inflation trigger housing 17 has a trigger ball 5 connected to a trigger belt 7, which is in turn connected to a multi-connector 11 or directly to a retractable belt 8 from a belt-retractor with emergency locking 9, the belt-retractor 9 is connected to a part of a motorcycle 10 (FIG. 22). The rider connects multiple trigger belts 7 from the mechanical inflation trigger housings 17 to each other via the multi-connector 11 when riding. The rider disconnects the multi-connector 11 when not riding, leaving the belt-retractor 9 on the motorcycle, and walks away with the mechanical inflation trigger housings 17 and the trigger belts 7 attached to the airtunnels 12 mechanical inflation trigger housings 17.

In this example, the belt-retractor 9 will offer movement to the rider by expanding and retracting the retractable belt 8 in the belt-retractor 9. When the rider is experiencing a sudden or hard movement the belt-retractor 9 will lock the retractable belt 8 connected to the multi-connector 11, which is connected to the trigger belts 7. When the belt-retractor 9 is locked the mechanical inflation triggering housings 17 has become armed. If the sudden movement that locked the belt-retractor 9 is followed up by substantial force the armed multi-connector 11 connected to the trigger belts 7 will pull out the trigger balls 5 from the inflation trigger housings 17 and rapidly inflate the outfit. If the locked and armed retractable belt 8 is not followed up by substantial force the belt-retractor 9 will release its lock and offer movement to the rider again.

The inflation of the airtunnels 12 occurs when the trigger balls 5 are pulled out from the inflation trigger housings 17 with substantial force. The trigger balls 5 separate, and a sharp metal-piece 20 inside the inflation trigger housings 17 punctures the gas or fluid tank 14. The sharp metal-piece 20 is moveable by a spring 21, in this example. When the trigger balls 5 are pulled out of the inflation trigger housings 17, the sharp metal-piece 20 moves under force of the spring 21 piercing a hole 22 in the gas or fluid tank 14, causing the gas or fluid tank 14 to release the gas or fluid and inflate the airtunnels rapidly (FIG. 25).

The mechanical inflation trigger housing 17 is placed in a pocket 6 or hidden under a cover, outside the garments in the outfit. A hard-shell layer 61 separates the inflation trigger housings 17 from the body of the rider.

The inflation gas can be replaced with new gas or fluid tanks 14 once used.

The outfit further comprises one or more electrical inflation trigger housings 23, using chemical material such as pyrotechnics that rapidly produces gas or fluid when ignited, or a hybrid solution between stored gas or fluid and chemical material.

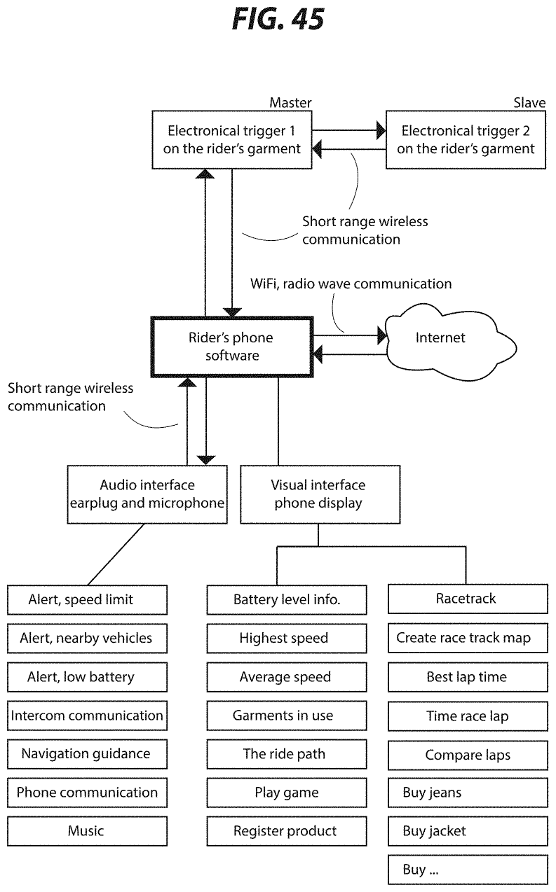

The electrical inflation trigger housings 23 uses micro sensors, such as (MEMS), which are commonly used in car airbags for triggering the inflation. The electrical inflation trigger housings 23 also measures conditions such as speed, angles, xyz-positions, previous tracked movements, abrupt movements, time, close by vehicles and other conditions for determining if an accident is going to occur or has occurred and/or for giving the rider feedback regarding the ride to a phone software (FIG. 45).

The electrical inflation trigger housings 23 comprise electronic triggering control, one or more sensors, one or more energy sources, electronic hardware, Bluetooth® hardware, a phone as display and interface, a phone software (FIG. 45), one or more earpieces, one microphone, inflation triggering software, one or more enclosed housing for the electrical inflation trigger housing 23, chemical material that produces gas when ignited and/or gas or fluid tanks.

The electrical inflation trigger housings 23 are interconnected wirelessly to each other, exchanging information 24 to make a more precise conclusion when to inflate. Two or more garments needs to transmit the triggering signal for the system to inflate, avoiding unintentional inflation when two or more garments in the system uses electrical inflation triggering housings 23.

The electrical inflation trigger housings 23 operates as master and slaves, with the master controlling multiple electrical inflation triggering housings as slaves (FIG. 45). If the rider only uses one of the garments in the system, then the one garment operates as the master.

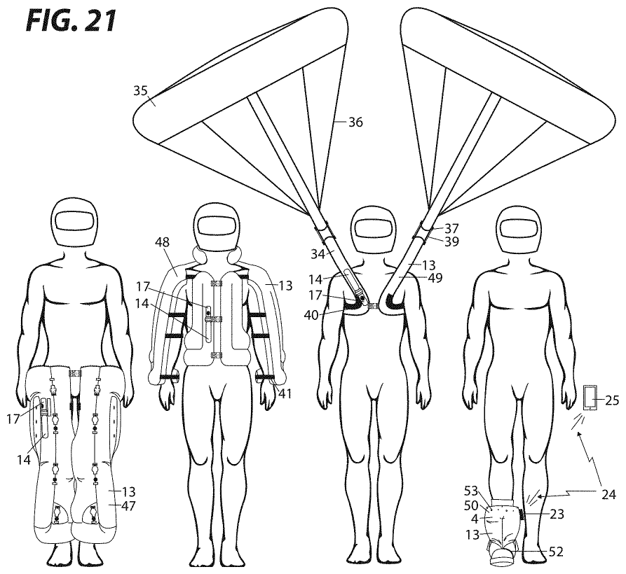

Information measured by the electrical trigger housings 23 is saved and sent wirelessly 24 to a software in the rider's phone 25 (FIG. 21), using Bluetooth® technology and/or radio wave or other wireless communication technology. The phone 25 operates as the display and interface for the electrical inflation trigger housings 23. The information may contain battery level information, average speed, highest speed and other relevant information regarding the system and the rider's ride. The software will send messages when the battery is low to the rider's phone 25 and the software can be updated via an Internet connection.

The information can be used by the rider to time himself on a racetrack, illustrate the rider's path and build a digital race track map, show the best lap times and compare laps (FIG. 45).

The software has a phone interface inspired by the graphical design of motorcycle video games. The interface illustrates the outfit and highlights the garments in use with options to directly buy products in the phone software (FIG. 45).

The software also includes a motorcycle video game and the rider can play the motorcycle game from the phone 25, compete with other users and win prizes.

The information gathered by the electrical inflation trigger housings 23 can also be used after an accident situation to determine the cause of an accident.

The outfit in the system can further be complimented with an inflatable motorcycle helmet. The inflatable helmet offers freedom for the head by eliminating the traditional motorcycle helmet structure and offer a helmet structure that partly is open.

Further embodiments of the system comprise an inflatable motorcycle outfit (FIG. 1) with inflatable garments for the feet (FIGS. 17-20), lower body (FIGS. 2-7), and upper body (FIGS. 10-16) that can be worn as one complete outfit and/or be worn as separate garments with or without an airtunnel structure (FIGS. 4, 10, 13, 19) arranged inside, outside or together with the garments. Offering riders impact, abrasion, heat and speed reducing properties in a motorcycle accident situation. The outfit gives riders the option to customize the outfit based on suitable protection level, the weather condition, comfort, style, economy, social circumstances and other factors relevant for the rider and the ride. In the following paragraphs, use of “the embodiment” refer to benefits of the inflatable outfit discussed above, including all components thereof either in combination or individually. To wit:

The embodiment of the outfit is to have airtunnels 12 overlaying the areas around the hips, the knees, the waist, the pelvis, the butt, the upper back legs, the upper front legs, and the outer-sides of the entire legs, the neck, the chest, the side of the chest, the upper abdominal, the lower abdominal, the side of the abdominal, the spinal column, the lower back, the rear of the ribs, the front, rear and outer-sides of the shoulders, the entire outer-side of the arms, the elbows, all around the connection between the hands and the lower arms, the outer and inner side of the feet, the top of the feet, the ankles, the right and left side of the head and around the hand connection to the lower arm. This embodiment covers a wide range of areas of the body with impact reducing protection in the event of a motorcycle accident (FIGS. 4, 10, 13, 19).

The embodiment is to cover parts of the body with airtunnels 12 and leave areas of the body empty, so wind can pass through the system when riding. This embodiment enable ventilation for the rider on warm days.

The embodiment is to have airtunnels 12 aligning in the same direction as the underlying skeleton on lower body (FIGS. 4, 5). The airtunnels overlays the upper leg on the front, the outer-side and the rear. The airtunnels overlays the lower leg on the front, the inside, the outer-side and part of the rear. This embodiment enhances the body's natural impact absorber, the skeleton. Injuries to the legs are the most common injury in a motorcycle accident, topping the list of impact injuries.

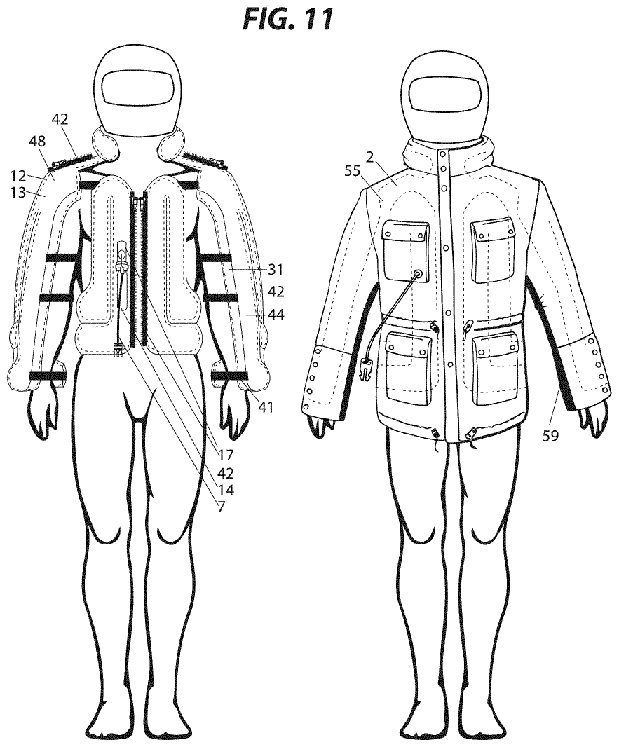

The embodiment is to cover the kneecaps with airtunnels 12 on the front, outer-side, inner-side and not on the rear part of the kneecaps were the legs fold, because of movability (FIGS. 4, 5). The same principle is applied for the elbow area were airtunnels 12 do not cover the area between the upper arm and lower arm were the arms folds (FIG. 11). This embodiment makes the outfit comfortable to wear when walking and sitting on the motorcycle.

In one embodiment, Viscoelastic, soft, or hard-shell protectors can be attached on airtunnel shells overlaying the knees, the spinal column, the shoulders and the elbows. The protectors can be attached on the airtunnel shells in pockets or directly attached to the airtunnel shells with Velcro® 30 or similar attachments. The embodiment enables the impact forces to be distributed over a bigger area on the airtunnel shells 13 and absorbs energy more effectively.

The embodiment is to have the airtunnel structure for the lower body 47 running vertically on the front and the outer-sides of the legs, further, run vertically on the rear part of the upper legs until the kneecap area (FIG. 5). This embodiment enables movability and covers the whole front and outer-sides of the lower body with impact and abrasion reducing protection.

The embodiment is to use one airtunnel 12 for each garment in the system (FIG. 8), except for the boots 4 that needs two. The airtunnel 12 is made from airproof material and have one mechanical 17 or electrical inflation trigger housing 23 connected to the airtunnel 12. The airtunnel 12 can be bigger in width and height than its respective airtunnel shell 13 that determines the shape of the inflated airtunnel structures 47, 48, 49, 50. The shape is determined by using an intermediate material 31 in the construction of the airtunnel shells 13.

The embodiment is to construct the airtunnel shells 13 for the upper and lower body, so it can inflate and fit inside the limbs of a trouser 1 and/or the limbs of a jacket 2 (FIG. 2, 11). By using an intermediate material 31 stitched between the bottom material 43 and the top material 42 of the airtunnel shells 13 in the construction of the airtunnel structures 47, 48, 49, 50. The intermediate material 31 reduces the width and increases the height of the airtunnel shells 13 (FIGS. 43, 44), obtaining the air volume required for the impact reducing properties . This embodiment enables the airtunnel shells 13 to fit inside the legs of a trouser 1 and the arms of a jacket 2 because of the reduced width. The intermediate material 31 enables the inflated airtunnel shells 13 to have a pre-determined shape when inflated by cutting the intermediate material 31 in different shapes. The intermediate material 31 enables for a greater distance between the impact environment and the body of the rider by having a greater perpendicular distance, an increased distance between the body and the impact forces. The required air volume for the different body parts can differ and the width of the airtunnel shells 13 are changeable to fit specific body parts, for example around the foldable areas of the limbs.

The embodiment is to place airtunnels 12 in airtunnel shells 13 that allows the airtunnels 12 to expand by unfolding an intermediate material 31 in the construction of the airtunnel shell 13. The intermediate material 31 is hidden (FIG. 41) with attachments such as buttons 53, Velcro® 30 and/or stitched with stiches that can break when inflated. The intermediate material 31 is released when inflated (FIG. 42) to provide more space for the airtunnels 12 in the airtunnel shells 13 when expanding.

The embodiment is to construct the airtunnel structure for the upper body 48 and the lower body 47 as stretchable structures by connecting parts of the airtunnel structures 47, 48 with elastic ribbons 41 to itself or around a body part. The elastic ribbons 41 enable the otherwise non-stretchable airtunnel structures 47, 48 to become stretchable when worn, offering comfort for the rider when wearing the system.

In one embodiment the airtunnel shells 13 have ventilation holes 27 located on the airtunnel shells 13 for ventilation (FIGS. 4, 10). The ventilation holes 27 can be closed 28 and opened by a cover 29 with attachments such as buttons 53 and/or Velcro® 30. This embodiment enables the rider to customize the system.

In one embodiment the airtunnel shells 13 are contructed with mo'cycle airtunnel material 44 (FIGS. 30, 31). The mo'cycle airtunnel material 44 has the tensile strength, abrasion and heat resistant properties suitable for a motorcycle accident situation in one mono-layer material. The material 44 is used towards the impact side in an accident situation and used as the top material in constructing the airtunnel shells 13 but can also be used as the intermediate material 31 and bottom material 43.

The embodiment is to create the weft and warp yarn for the mo'cycle airtunnel material 44 with abrasion 46 and heat 45 resistant fibres. The abrasion resistant fibres 46 have long continuous filaments and the heat resistant fibres 45 have a melting point above 100 degrees Celsius, 212 degrees Fahrenheit. The yarn is, in one embodiment, obtained by weaving a 1/1 twill. This embodiment protects the riders body, the airtunnel shell 13 and the vulnerable airproof airtunnels 12 from abrasion, impact and friction heat that can cause injuries and holes in the airproof airtunnels 12.

In one embodiment the stretchable mo'cycle denim material 55 (FIG. 27) is used as outer shell material for the trouser 1 and jacket 2 to enable inward inflation. The yarn in the warp direction (FIG. 29) have abrasion resistant fibres 46 with long continuous filaments combined with natural fibres 56. The yarn in the weft direction (FIG. 28) have abrasion resistant fibres 58 with short continuous filaments, elastic fibres 57 and natural fibres 56 from animals or vegetation. This embodiment enables the mo'cycle denim to have stretch properties for the inward inflation, be abrasion resistant in an accident situation and look like traditional denim fabric in its structure and feel, enabling riders to ride in impact reducing motorcycle jeans.

The embodiment is to obtain the mo'cycle denim material 55 by, in one example, weaving a 2/1, 3/1 or 4/1 twill resembling ordinary denim fabric in its structure (FIG. 27).

In one embodiment the knitted mo'cycle material is used in combination with weaved mo'cycle denim material 55 as the outer shell material for the trouser 1 and jacket 2 in the system to enable inward inflation.

The embodiment is to obtain the knitted mo'cycle material by weft knitting which enables high stretch properties in the horizontal direction.

The embodiment is to use zippers 42, buttons 53 or similar attachments to attach airtunnel shells 13 inside a trouser 1 and/or a jacket 2. The trouser 1 and jacket 2 can be interchanged when new models compatible with the airtunnel shells 13 are available. By constructing parts of the system interchangeable the rider can machine wash the different garments in the system and choose how to wear the system.

The embodiment is to remove the airtunnel structures for the upper body 48 and the lower body 47 and only ride in the trouser 1 and the jacket 2. This embodiment would offer comfortable, stretchable and abrasion resistant properties but the impact reducing properties would be lost. This embodiment offers the trouser 1 and jacket 2 to be used as ordinary fashion apparel made from high quality material that can last many years for riders and non-riders.

The embodiment is to have airtunnel shells 13 overlaying the boots 4 in the areas around the front, the sides and the rear of the boots 4, further, on the top of the boots 4 (FIG. 20). The airtunnel shells 13 has an intermediate material 31 folded and buttoned down on the boots 4, when inflated the buttons 53 will release and allow the airtunnel shells 13 intermediate material 31 to expand outwards (FIG. 19). The intermediate material 31 can be attached to the boots 4 using buttons 53, Velcro® 30, stitching that can break apart or other attachments in any combination (FIGS. 41, 42).

The embodiment is to have outward expanding inflation for the airtunnels 12 in the boots 4 and the vest 3 in the system.

The embodiment is to fold the airtunnel-canopies 49 into a garment resembling a vest 3, a jacket or a backpack worn around the armpits (FIG. 16).

The embodiment is to inflate the airtunnel-canopies 49 in the vest 3 with gas or fluid to rapidly deploy the wind catching canopy structures 35 in an accident situation were rapid inflation is critical. The canopy structures 35 are inflated to the edges of the canopy structures 35 to guarantee rapid deployment regardless of factors such as speed, body position, motion, wind, in an accident situation. The speed reducing properties are instantly activated the moment the wind catches the inflated, deployed canopies.

The embodiment is to use one or more square shaped, inflatable, canopy structures 35 (FIGS. 13-15) for catching the wind. The inflatable squared shaped 35 canopies enable for a more stable and straight descent line when deployed. Triangular, rectangular and round shaped canopies can also be used but they don't have the same straight line of descent as square shaped canopies have.

The embodiment is to eject the inflatable canopy structures 49 upwards by gas or fluid in an accident situation. The embodiment makes the body exhibit a horizontal alignment with the legs towards the motion direction when the wind catches the canopies 35 due to the forward motion of the rider in an accident situation. This position is desirable because the legs can fold and absorb energy which increases the chance of surviving in an accident situation.

The embodiment is to align the wind stopping force from the canopies 35 vertically in line with the body. The airtunnel-canopies 49, enables the wind stopping force to be absorbed vertically through the body and absorbed around the armpit areas. The airtunnel-canopies 49 inflates around the armpit areas thus absorbing some of the wind stopping force.

The embodiment is to reduce the abrupt wind stopping force, the moment the airtunnel-canopies 49 are deployed, by adding soft shock absorbing material 40 on the airtunnel-canopies 49 around the armpits. This embodiment will relieve the armpits from some of the abrupt stopping force when the canopies 35 are deployed.

The embodiment is to use elastic shock dampening ribbons 39 to additionally reduce the abrupt stopping force when the canopies 35 are deployed. The ribbons 39 are located on the airtunnel-canopies 49, between the shoulders and the canopy structures 35 next to the head (FIG. 14). The “C” shaped solution 38 enables the airtunnel-canopies 49 to be connected so rapid deployment can occur to the edges of the wind catching canopy structures 35 with gas or fluid. The inflated “C” shape 38 offers additional impact reducing protection for the head in the event the head is slugged sideward in an accident situation.

The embodiment is to use synthetic or natural rubber material or other elastic material with good extensibility, resilience and tensile strength for creating the “C” shaped shock dampening construction 38.

The embodiment is to attach the canopy suspenders 36 above the head of the rider, so the suspenders do not risk getting entangled around the neck of a rider in an accident situation.

The embodiment is to use a belt buckle with a quick release to attach the vest 3 around the body. The belt buckle needs to withstand the force when the vest 3 is inflated and catches the wind. This embodiment enables the rider to quickly take of the vest 3 after an accident and enables the vest 3 to withstand the wind stopping force without breaking apart.

The embodiment is to trigger and inflate the system with a mechanical inflation trigger housing 17 or an electrical inflation trigger house 23 for the lower body airtunnel structure 47, upper body airtunnel structure 48 and the airtunnel-canopies 49 in the system.

The embodiment is to activate and trigger the mechanical inflation trigger housings 17 with or without emergency locking from a belt-retractor 9. One part of the belt-retractor 9 is connected to a motorcycle 10 and the other part has a retractable belt 8 connected to a multi-connecter 11 or directly to a trigger belt 7 if only one garment is used from the system. The retractable belt 8 is connected to the multi-connector 11, the multi-connector 11 is connected to trigger belts 7 from the lower body airtunnel structure 47, upper body airtunnel structure 48 and the airtunnel-canopies 49. The trigger belts 7 are connected to trigger balls 5 in the mechanical inflation triggering housings 17 on airtunnel structures 47, 48, 49 (FIG. 22). The mechanical inflation triggering housings 17 enables for instant inflation without a separation distance to be reached. Mechanical inflation triggering housings 17 does not need to be charged and cared for in the same manner as an electrical inflation trigger housing 23.

In one embodiment garments can instantly deflate by using a mechanical inflation trigger housing 17 with a quick release air coupling connection 15, 16 (FIGS. 23-26). The gas or fluid tanks 14 can quickly be removed via the quick release and instantly deflate the system after an accident situation.

The embodiment is to trigger and inflate the inflatable boots 4 by electrical inflation triggering housings 23 on each boot. The triggers uses pyrotechnics to ignite chemical material that rapidly produces gas or fluid that inflates the airtunnel 12.

The embodiment is to equip the electrical inflation triggering housings 23 with hardware such as Global Positioning System, GPS, Bluetooth®, short- or long-range radio frequency hardware and sensors. Further, with software measuring conditions with the hardware such as speed, angles, xyz-positions, distances, previous tracked movements, abrupt movements, normal movements, time, close by vehicles and other conditions for determining if an accident is going to occur or to provide the rider with information. The information can be used in any combination to determine if an accident is going to happen or has happened.

The embodiment is to equip the rider with one or more earplugs or one or more speakers and a microphone connected wirelessly to the electronic inflation trigger housings 23 and a phone software (FIG. 45). This embodiment enables for an audio interface and communication between the electronic inflation trigger housings 23 and the rider. The audio interface can alert the rider about the speed, battery, close by vehicles and enable intercom communication, phone communication, listening to music, voice commands and more options.

The embodiment is to charge the electrical inflation trigger housings 23, the earplug and microphone with cables and/or wirelessly with inductive charging.

The embodiment is to wirelessly interconnect garments in the system that uses electrical inflation trigger housings 23 to each other. The electrical trigger housings 23 can exchange information 24 to make a more precise conclusion when to inflate, avoiding unintentional inflation.

The embodiment is to wirelessly connect two or more electrical inflation triggering housings 23 to each other so a more precise conclusion can be made when to inflate the system. Two triggering signals must be transmitted from two garments for the inflation to activate and inflate. The embodiment offers a failsafe solution that would decrease the risk for unintentional inflation.

The embodiment is to have one electrical inflation trigger housing 23 in the system operating as a master, controlling the other electronic trigger housings 23 as slaves. If the rider only uses one of the garments in the system with electrical triggering 23, then the one garment operates as the master. This embodiment enables for simultaneous inflation triggering and a failsafe solution for the garments using electrical triggering.

The embodiment is to use a phone 25 as display and visual interface for the electrical inflation trigger housings 23 to display information such as the battery level (FIG. 45) and other relevant information.

The embodiment is to save the measured information in the electrical inflation trigger housings 23 and send the information to a software in a phone 25 via a Bluetooth® connection, radio wave connection and/or an Internet connection.

The embodiment for the interface of the phone software (FIG. 45) is to illustrate the outfit in the system and highlight the garments the rider is using with battery level information.

The embodiment is to enable the rider to buy products directly in the phone software, play a motorcycle game and win prices, show average speed, highest speed, register the garments in use from the system, create a digital race track, time a race lap, show best lap times, compare laps and other relevant information about the system and the riders ride (FIG. 45).

In one embodiment the inflatable trouser 1 and airtunnel structure can be shorten and made as shorts. This embodiment offers benefits such as more movability when the airtunnels 12 are inflated, ventilation for riders in warm countries and a new look.

In one embodiment the airtunnel structure for the trouser 1 is made shorter in length. This embodiment uses less material and allows for more movability for the rider when inflated in an accident situation.

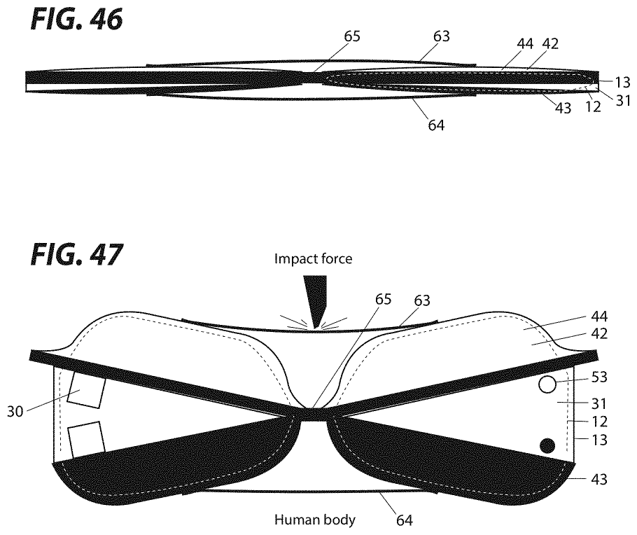

In one embodiment the airtunnel structure for the trousers 1 can be made as inflatable knee protectors. The inflatable protectors can for example be used for the knees and are soft when worn and becomes hard and tense when inflated, as shown generally with reference to FIGS. 46, 47. The exposed areas created by gaps or seams between adjacent airtunnel structures (i.e., another airtunnel or a portion of the same airtunnel) are covered, in this example. Specifically, airtunnels 12 placed side by side next to each other are stitched with a seam 65 on the airtunnel shells 13, and the seam 65 runs alongside the airtunnels 12 and exposes the body to possible impact. By using a top fabric 63 and a bottom fabric 64 the seam 65 can be covered. The top and bottom fabrics span between adjacent, parallel airtunnel sections. Once the airtunnels 12 are inflated, the top fabric 63 and bottom fabric 64 are stretched out and become hard due to the pressure from the inflation, creating a barrier over the seam 65.

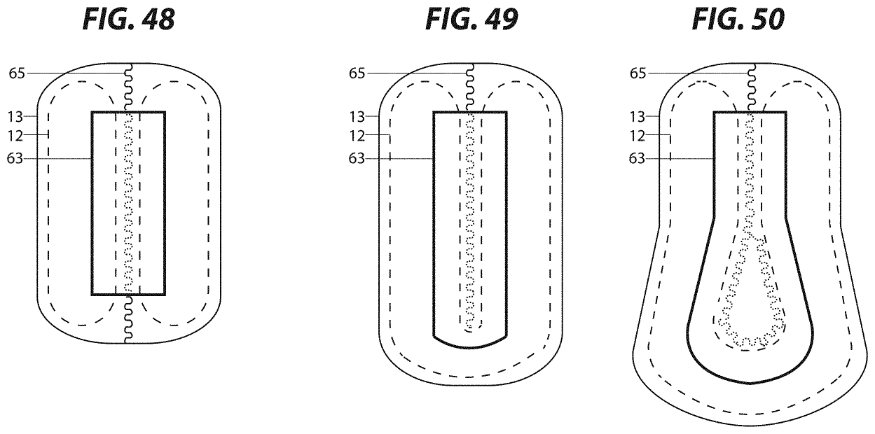

FIG. 48 shows how the top fabric 63 can be attached on the airtunnel shells 13 to cover the seam 65 when two airtunnels are placed side by side. The bottom fabric 64 is arranged similarly. FIG. 49 shows how the top fabric 63 can be attached on the airtunnel shells 13 to cover the seam 65 when one airtunnel makes a curve. As shown, the fabric 63 covers at least a portion of the curved section of the airtunnel. FIG. 50 shows how the top fabric 63 can be attached on the airtunnel shells 13 to cover different body parts.

One embodiment is to use any stretchable material 62 as the outer shell material for the trouser 1 and jacket 2 in the system (FIG. 33). A layer of abrasion resistant protection would be lost making the embodiment less safe for the airtunnels 12 and the rider in an accident situation.

An economical embodiment of the system would be to eliminate the stretchable and abrasion resistant trouser 1 and jacket 2 and only ride in the airtunnel structures for the upper body 48 and lower body 47 (FIG. 34). A layer of abrasion resistant protection would be lost and the look of the airtunnel structures 47, 48 would be function-oriented when worn.

One embodiment is to construct the airtunnel structures 13 for the upper body 48 and the lower body 47 in a manner that makes the airtunnel structures 47, 48 self-contained (FIGS. 6, 7, 12) without the need for any additional garment. This embodiment would have outward expanding inflation for the trouser (FIGS. 6, 7) and jacket (FIG. 12). The design of such embodiment would be function-oriented revealing that the garments are protective apparel.

One embodiment is to construct the trouser and jacket with outward inflation (FIGS. 6, 7, 12). This embodiment would be economical but the abrasion resistant layer in the outer shell of the trouser 1 and jacket 2 would be lost.

One embodiment is to construct the airtunnel structure for the upper body 48 without any airtunnels 12 overlaying the arms. This embodiment would provide movement for the arms when the airtunnel structure 48 is inflated. The disadvantage is that the lower arms would not be covered by inflatable impact reducing protection. Traditional Viscoelastic, soft or hard-shell protectors could be used to cover the lower arms with impact reducing protection.

One embodiment is to construct foldable airtunnel shells 13 on the areas were the limbs fold. By reducing the air volume and/or shaping the airtunnel shells 13 the limbs can be folded when the airtunnels 12 are inflated.

In one embodiment any material with tensile strength to withstand the rapid inflation from the airtunnels 12 can be used for constructing the airtunnel shells 13 in the system. The level of protection would decrease leaving the vulnerable airtunnels 12 unprotected from abrasion and friction heat that can cause holes in the airproof structures in an accident situation. This embodiment would be economical, but the safety would be compromised.

In one embodiment the intermediate material 31 in the construction of the airtunnel shells 13 can be removed. The airtunnel shells 13 would need to be constructed in a wider design so the airtunnels 12 has enough space to expand when inflated. The design of airtunnel shells 13 without an intermediate material 31 would need to be wider in width and based on the required air volume. This embodiment would make the design of the garments function-oriented and the airtunnel shells 13 would not fit inside the arms of a jacket and provide the required air volume needed

One embodiment would be to construct the mechanical inflation trigger housing 17 without a belt-retractor 9 for connecting the trigger belts 7. The embodiment would require a separation distance and delay the critical inflation time.

One embodiment would be to construct the mechanical inflation trigger housing 17 without a quick release connection for instant deflation. The embodiment would not have an instant deflation solution and the rider would need to manually screw of the gas or fluid canister for deflation or wait until the garment self deflates.

One embodiment would be to construct the airtunnel structure for the lower body 47 with horizontally aligned airtunnels 12 on the lower body. The horizontally aligned airtunnels 12 can run in a circular shape around the legs. This embodiment would offer horizontally aligned impact reducing protection for the vertically aligned skeleton structure in the legs which is not optimal.

One embodiment would be to only have a vertical aligned airtunnel 12 on the front of the legs and not overlay the airtunnel around the lower leg and foot connection. The embodiment would be easier to produce but the impact reducing protection for the lower legs and ankles would be lost.

One embodiment would be to overlay the lower body with an airtunnel 12 only on the front legs, and/or only on the outer sides of the legs and/or only on the rear side of the legs. The less areas the airtunnel 12 overlays the body the less impact reducing protection is obtained.

One embodiment would be to make the trouser 1 and jacket 2 and/or the airtunnel structures 47, 48 wind and/or water proof, resistant or repellent. The properties can be obtained by coating the material or fibres the garments are made from. Nanotechnology and other techniques can be used to obtain the properties in the materials for the garments.

In one embodiment viscoelastic soft- or hard-shell protectors can be attached on any part of the airtunnel shells 13 in the system. The protectors enhance the impact reducing properties of the system. The protectors enable the impact force to be distributed over a bigger area on the inflated airtunnel shells 13 which absorbs the impact energy more effectively. The embodiment would become heavier, less comfortable and more expensive.

In one embodiment the airtunnels shells 13 in the system could be made wider so more air volume can be obtained to protect wider areas of the body. This embodiment would increase the impact reducing abilities, but the system would become bigger in size, heavier, require more gas or fluid volume, more material, a wider fit and become more expansive.

In one embodiment more airtunnels 12 can be added for impact reducing protection, such as airtunnels 12 overlaying the inner side of the arms, inner side of the legs and the rear part of the lower legs. This embodiment would become heavier, less comfortable, require more gas or fluid, more material and become more expensive.

More economical embodiments can be obtained by using cheaper material in the construction of the system and save on material costs. The embodiments would be economical, but the overall quality of the system would decrease and the level of protection would decrease.

In one embodiment the inflation of all garments in the system are triggered by electrical inflation trigger housings 23. This embodiment eliminates the need for physical belts and offer more freedom for the rider.

In one embodiment a pressure sensor can be placed in the seat of the motorcycle. The pressure sensor would be in communication with one or more electrical inflation trigger housings 23 to determine if the rider has been removed from the motorcycle. The embodiment would offer a failsafe solution for unintentional inflation and for a more accurate triggering decision by the triggering housings 23.

In one embodiment the “C” shaped shock absorbing solution 38 could be removed from the airtunnel-canopies 49. This embodiment would lose shock absorbing properties and the body would be exposed for a stronger abrupt force the moment the canopies 35 are deployed and catches the wind.

In one embodiment the airtunnel 12 for the airtunnel-canopies 49 does not inflate to the edges of the canopy structures 35. The embodiment would eject the canopies 35 from the vest 3 and let the wind fully deploy the canopy structures 35.

In one embodiment warning triangles or other warning signs are attached or printed on the canopy structures to warn and make the public aware of an accident. The warning signs can be made luminous and/or reflective for optimal visibility.

In one embodiment zippers, Velcro® 30, belt loops or other attachments can be used for connecting the vest 3 around the body. The connections need to withstand the wind stopping force the moment the canopies 35 catches the wind.

While the inflatable outfit has been described herein relative to motorcycles, this disclosure could be used in other contexts, such as in extreme sports, for example. In particular example, this disclosure may be used to provide protection for users of flyboards, jetsuits, etc.

Herein above has been described a system of an inflatable motorcycle outfit and examples of methods for creating the system. However, one of ordinary skill in this art would understand that the above described embodiments are exemplary and non-limiting. The different steps can be performed in other combinations than those identified above, with different materials, different fibres, in different dimensions, etc., without departing from the scope of this disclosure.

1. A system providing an inflatable outfit, comprising:
a garment including an airtunnel formed therein, the airtunnel configured to inflate at least partially inwardly.

2. The system as recited in claim 1, further comprising a piece of fabric spanning a gap between the airtunnel and either (1) an adjacent airtunnel or (2) a portion of the same airtunnel, wherein the piece of fabric is configured to harden and become tense when the airtunnel inflates.

3. The system as recited in claim 1, wherein the garment includes a layer of material surrounding the airtunnel, the layer of material including denim

4. The system as recited in claim 3, wherein the layer of material includes denim interwoven with another material such that the layer of material is stretchable denim

5. The system as recited in claim 1, wherein the airtunnel is configured to surround substantially an entirety of a limb of a user.

6. The system as recited in claim 5, wherein the limb is one of an arm and a leg.

7. The system as recited in claim 1, wherein the garment is a first of a plurality of garments within the outfit, and wherein the first garment include trousers, and wherein a second garment includes a jacket, a third garment includes a vest, and a fourth garment includes boots, and further wherein each of the garments includes a respective airtunnel configured to be filled by gas or fluid.

8. The system as recited in claim 7, wherein the airtunnel of the boot is configured to inflate outwardly.

9. The system as recited in claim 7, wherein the airtunnels of the trouser, vest, and jacket are configured to inflate at least partially outwardly.

10. The system as recited in claim 7, wherein at least some of the respective gas or fluid tanks are coupled to respective trigger housings, and wherein the trigger housing are configured to couple to a belt system which, when a force is applied thereto, causes the gas or fluid tanks to release gas or fluid and fill a respective airtunnel.

11. The system as recited in claim 10, wherein trouser and/or jacket comprises a stretchable material.

12. The system as claim 1, wherein, when the airtunnel is filled with gas or fluid it inflates one or more canopies.

13. An inflatable outfit, comprising:
a trouser, a jacket, a vest, or a boot, comprising:
an airtunnel formed therein, the airtunnel configured to inflate at least partially inwardly.

14. The inflatable outfit as recited in claim 13, wherein the trouser, jacket, vest, or boot includes a layer of material surrounding the airtunnel.

15. The inflatable outfit as recited in claim 14, wherein the layer of material includes denim interwoven with another material such that the layer of material is stretchable denim

16. The inflatable outfit as recited in claim 13, wherein the airtunnel is configured to surround substantially an entirety of a limb of a user.

17. The inflatable outfit as recited in claim 16, wherein the limb is one of an arm and a leg.

18. The inflatable outfit as recited in claim 13, wherein the outfit includes at least two of a trouser, a jacket, a vest, and a boot, each including a respective airtunnel configured to be filled by gas or fluid.

19. A method, comprising:
inflating an airtunnel of a garment at least partially inwardly toward a limb of a user.

20. The method as recited in claim 19, wherein the garment is a trouser, a jacket, a vest, or a boot.
